(19) United States
(12) Patent Application Publication
(10) Pub. No.: US 2014/0122825 A1
(43) Pub. Date: May 1, 2014

(54) COMPUTER SYSTEM AND METHOD FOR UPDATING CONFIGURATION INFORMATION

(71) Applicants: Yasutaka Kono, Kawasaki-shi (JP); Daisuke Shinohara, Yokohama-shi (JP); Jun Nakajima, Yokohama-shi (JP); Masataka Nagura, Yokohama-shi (JP)

(72) Inventors: Yasutaka Kono, Kawasaki-shi (JP); Daisuke Shinohara, Yokohama-shi (JP); Jun Nakajima, Yokohama-shi (JP); Masataka Nagura, Yokohama-shi (JP)

(73) Assignee: HITACHI, LTD., Tokyo (JP)

(21) Appl. No.: 13/696,350

(22) PCT Filed: Oct. 30, 2012
(86) PCT No.: PCT/JP2012/006937

§ 371 Date: Nov. 26, 2012

(51) Int. Cl. G06F 12/02

(52) U.S. Cl. CPC G06F 12/023
USPC 711/170

(57) ABSTRACT

In a configuration where a virtual storage array is formed in a physical storage array, if a physical storage administrator acquires a lock for all the physical storage arrays during update of information of multiple physical storage arrays, not only all the physical storage arrays but also all the virtual storage arrays formed therein cannot be manipulated while information update is executed. According to the present invention, when a virtual storage administrator executes change of configuration of the virtual storage array while the physical storage administrator is performing information update of all multiple physical storage arrays and management operation from the virtual storage administrator is not prohibited, the information of the changed configuration is stored in a temporary area of a configuration information database, and at the last of information update, the information of the temporary area is reflected to a normal area of the configuration information database.

### TECHNICAL FIELD

The present invention relates to managing configuration of a storage array, and more specifically, relates to the method for updating configuration information of a storage array retained by management software.

### BACKGROUND ART

Recently, the amount of data being used by companies or individuals is increasing sharply. Therefore, storage systems adopting techniques such as a SAN (Storage Area Network) or a NAS (Network Attached Storage) that couple storage arrays and host computers via switches or hubs to enable flexible data management are used widely.

Recently, there has been proposed a technique of constructing a virtual storage array within a physical storage so as to efficiently utilize resources that the storage array has. One example of such method is disclosed in patent literature 1. Patent literature 1 discloses constructing virtual storage arrays smoothly from independently operated physical storage arrays, by assigning two identifiers to resources such as storage areas included in physical storage arrays, one identifier being an identifier unique among multiple physical storage arrays (first identifier) and an identifier unique within a single physical storage array (second identifier), wherein when an access request designating a first identifier is received from a host computer, the first identifier designated in the request is converted to a corresponding second identifier. By adopting such technique to allocate a resource that multiple physical storage arrays have to the virtual storage arrays, the host computer can utilize the resource as a resource included in a single virtual storage array, without being conscious of the physical boundaries of the storage arrays. Further, multiple virtual storage arrays can be constructed in physical storage arrays, and the corresponding relationship between the subsystems can be a multiple-to-multiple relationship.

On the other hand, along with such complication of storage systems, the costs related to operating the storage systems have become an important issue. One method for solving such problem is to manage the configuration of the storage system including the storage arrays, the host computers, the switches and the hubs via unified control using management software. One example of such method is taught in patent literature 2. By using such technique, the administrator of the storage system can perform management operations, such as referring to connections of multiples storage resources between multiple storage arrays and multiple host computers, or newly allocating resources from storage arrays to host computers, using single management software.

In a configuration where virtual storage systems are constructed within physical storage arrays, there normally exist an administrator for collectively managing multiple physical storage arrays (hereinafter referred to as “physical storage administrator”) and an administrator for managing individual virtual storage arrays constructed therein (hereinafter referred to as “virtual storage administrator”). The physical storage administrator performs management such as the physical maintenance of storage arrays (such as exchanging failure disks) and allocating resources to virtual storages. In contrast, the virtual storage administrator performs management such as the allocation of storage areas included in the virtual storages to the host computer, or creation of copies and backups of storage areas. Furthermore, virtual storage arrays are constructed to correspond to business units or the like, so that administrators exist for each of the respective virtual storage arrays. As described, in a configuration where virtual storage arrays are formed in the physical storage arrays, multiple administrators with different roles manage respective physical storage arrays and virtual storage arrays.

### CITATION LIST

### Patent Literature

PTL 1: Japanese Patent Application Laid-Open Publication No. 2008-40571 (United States Patent Application Publication No. US2008/0034005)
PTL 2: Japanese Patent Application Laid-Open Publication No. 2002-63063 (U.S. Pat. No. 7,103,653)

### SUMMARY OF INVENTION

### Technical Problem

As described, by applying prior art techniques, it becomes possible to manage a storage system composed for example of storage arrays, host computers, switches and hubs via single management software in an integrated manner During management of configuration in which a virtual storage array is constructed in a physical storage array, similar to the prior art where only the physical storage array is managed, update of information becomes necessary to match the actual configuration of the storage array and the configuration information of the storage array that the management software retains in the memory or the disk of the management computer. However, as mentioned earlier, in a construction where a virtual storage array is composed in a physical storage array, multiple administrators having different roles manage physical storage arrays and virtual storage arrays independently, and each administrator executes management operations such as the update of information and change of configuration of the storage arrays at arbitrary timings.

According to the prior art method for updating information, it is necessary to acquire a lock for prohibiting change of configuration of the storage arrays in order to acquire a consistent information update result. Therefore, in case the prior art method for updating information is performed within the configuration where virtual storage arrays are formed in the physical storage arrays, wherein the physical storage administrator updates information of the whole multiple physical storage arrays, it is necessary to acquire a lock for all the physical storage arrays. However, if a lock for all physical storage arrays is acquired, during update of information, not only all the physical storage arrays but also all the virtual storage arrays formed therein cannot be manipulated. Recently, along with the increase of the number of storage arrays installed in data centers of companies and the like, the time required for information update has been extended, and thus, the time during which the virtual storage array cannot be manipulated is also extended. The virtual storage administrator is also capable of performing information update of the virtual storage at any convenient timing. At this time, according to the prior art information update method, only a portion of the information visible from the physical storage administrator (only the information of a portion of the area of the whole information that the virtual storage administrator has updated information) reflects the latest information, and the information as a whole becomes inconsistent. This problem must be solved, since it may lead to the physical storage administrator performing management operations based on misjudgment.

### Solution to Problem

According to the present invention, when the management software updates information, the information update of the physical storage arrays and the virtual storage arrays are performed without prohibiting the management operations of the virtual storage administrator. Since the management operation of the virtual storage administrator is not prohibited, any arbitrary virtual storage administrator can change the configuration of the virtual storage arrays during update of information. If the virtual storage administrator performs change of configuration of the virtual storage array while the physical storage administrator is updating information of the whole multiple physical storage arrays, the information related to the changed configuration is stored in a temporal area of the configuration information database that the management software has. Then, at the last of the information update processing, the information in this temporal area is reflected in the normal area of the configuration information database. Further, in order to reduce the occurrence of change of configuration during information update, the order of information update is changed dynamically based on the relationship between resources of the physical storage arrays and the virtual storage arrays or between resources of the mutual virtual storage arrays, to thereby efficiently perform information update.

According further to the present invention, the configuration information of the storage array is retained by dividing the same into a data area for the physical storage administrator and a data area for the virtual storage administrator. When the physical storage administrator updates information of the whole multiple physical storage arrays, the data area of the physical storage administrator is updated, and when the virtual storage administrator updates information of the virtual storage array, the data area of the virtual storage administrator is updated. As for the virtual storage array, the timing in which information update is executed by the physical storage administrator and the timing in which the information update is executed by the virtual storage administrator are compared, and if the timings are close, information is prevented from being gathered multiple times from virtual storage arrays, and the information obtained via a single gathering of information is reflected to both the data area of the physical storage administrator and the data area of the virtual storage administrator.

### Advantageous Effects of Invention

According to the present invention where a virtual storage array is constructed within a physical storage array, consistent information update becomes possible without having to acquire a lock of the storage array. Thereby, it becomes possible to prevent a state where the virtual storage administrator cannot execute management operations to the virtual storage array for a long period of time, so that the efficiency of management operations can be improved. Further, even when the physical storage administrator and the virtual storage administrator perform information update at different timings, it becomes possible to prevent only a portion of the information visible from the physical storage administrator from being updated, and the consistency of the configuration information as a whole can be maintained. Furthermore, if information update by the physical storage administrator and the information update by the virtual storage administrator are executed at close timings, the same configuration information of the virtual storage array is prevented from being gathered multiple times, according to which the information update time can be shortened and the load applied on the storage array can be reduced.

Other related characteristic features of the present invention will become apparent from the following description, or can be learned from execution of the present invention. The aspects of the present invention are achieved and realized through the combination of various elements, the following detailed description of the invention and the aspects of the accompanying claims.

The description of the present specification is aimed at describing the present invention in a typified manner, and must not be used in any way to limit the scope of the claims and the application of the present invention.

For example, the target managed by the management software is not restricted to the storage array, but can include the host computers, the switches, the hubs, and the application programs operated in the host computers.

### BRIEF DESCRIPTION OF DRAWINGS

FIG. 1 is a view showing a system configuration according to embodiment 1.

FIG. 2 is a view showing an outline of the configuration of a virtual storage array according to embodiment 1.

FIG. 3 is a view showing a detailed configuration of a virtual storage array according to embodiment 1.

FIG. 4 is a view showing one example of a group of configuration information tables.

FIG. 5 is a view showing one example of a group of configuration differential information tables.

FIG. 6 is a view showing one example of a storage information table.

FIG. 7 is a view showing one example of a virtual storage information table.

FIG. 8 is a view showing one example of a storage related information table.

FIG. 9 is a view showing one example of a physical resource information table.

FIG. 10 is a view showing one example of a pool information table.

FIG. 11 is a view showing one example of a virtual pool information table.

FIG. 12 is a view showing one example of a pool related information table.

FIG. 13 is a view showing one example of a volume information table.

FIG. 14 is a view showing one example of a volume allocation information table.

FIG. 15 is a view showing one example of a storage differential information table.

FIG. 16 is a view showing one example of a virtual storage differential information table.

FIG. 17 is a view showing one example of a pool differential information table.

FIG. 18 is a view showing one example of a virtual pool differential information table.

FIG. 19 is a view showing one example of a volume differential information table.

FIG. 20 is a view showing one example of a volume allocation differential information table.

FIG. 21 is a view showing one example of a group of management information tables.

FIG. 22 is a view showing one example of a management task table.

FIG. 23 is a view showing one example of an information update status table.

FIG. 24 is a view showing one example of an information update time table.

FIG. 25 is a view showing one example of a process for storing a storage array as a management target of management software.

FIG. 26 is a view showing one example of the process for storing the management operation of a storage array to management software.

FIG. 27 is a view showing one example of the process in which the management software executes management operation of the storage array.

FIG. 28 is a view showing one example of a process for updating the configuration information of the storage array that the management software holds.

FIG. 29 is a view showing one example of the process in which the management software specifies the range in which change occurs by executing the management task.

FIG. 30 is a view showing one example of a range in which change occurs by executing the management task.

FIG. 31 is a view showing one example of a handling process related to the change of configuration having occurred during update of information of the storage array.

FIG. 32 is a view showing a system configuration according to a second embodiment.

FIG. 33 is a view showing one example of a group of configuration information tables according to the second embodiment.

FIG. 34 is a view showing one example of a group of management information tables according to the second embodiment.

FIG. 35 is a view showing one example of an information update status table according to the second embodiment.

FIG. 36 is a view showing one example of an information update status table by a virtual storage administrator according to the second embodiment.

FIG. 37 is a view showing one example of the process for registering a storage array as a management target of the management software according to the second embodiment.

FIG. 38 is a view showing one example of the process for updating the configuration information of the storage array that the management software holds according to the second embodiment.

FIG. 39 is a view showing one example of the process for updating the configuration information of the virtual storage array that the management software holds according to the second embodiment.

### DESCRIPTION OF EMBODIMENTS

Now, the preferred embodiments of the present invention will be described with reference to the drawings. In the following description, components having the same functions may be denoted by the same reference numbers. The accompanying drawings illustrate actual preferred embodiments and implementation examples in conformity with the principles of the present invention, but the drawings are intended to merely help understand the present invention and should not be used to restrict the scope of the present invention.

In the present preferred embodiments, sufficiently detailed description is provided so that those skilled in the art could be able to implement the present invention, but other modifications are possible, and it should be noted that changes in configuration or arrangement and the replacement of various components can be performed without deviating from the technical scope of the present invention. Thus, the following descriptions should not be used to restrict the interpretation of the present invention.

The embodiments of the present invention can be, as described earlier, implemented via a software operating in a general purpose computer, or a dedicated hardware, or a combination of software and hardware.

In the following description, various information according to the present invention are described in “table” format, but these information can be expressed via data structures other than tables, such as lists, DBs and queues. In order to show that the information does not depend on the data structure, the “tables”, “lists”, “DBs” and “queues” are sometimes simply referred to as “information”.

Expressions such as “identification information”, “identifier”, “name” and “ID” can be used for describing the contents of the respective information, and these terms are mutually replaceable.

The processes are sometimes described using the term “program” as the subject (subject of operation). The program is executed by a processor for performing determined processes using memories and communication ports (communication control units), so that a processor can also be used as the subject of the processes. The processes described using the program as the subject can also be set as processes performed by computers and information processing devices, such as management servers. A portion or all of the programs can be realized via a dedicated hardware, or can be formed into modules. Various programs can be installed to the respective computers via a program distribution server or storage media, for example.

### Embodiment 1

### A1. System Configuration

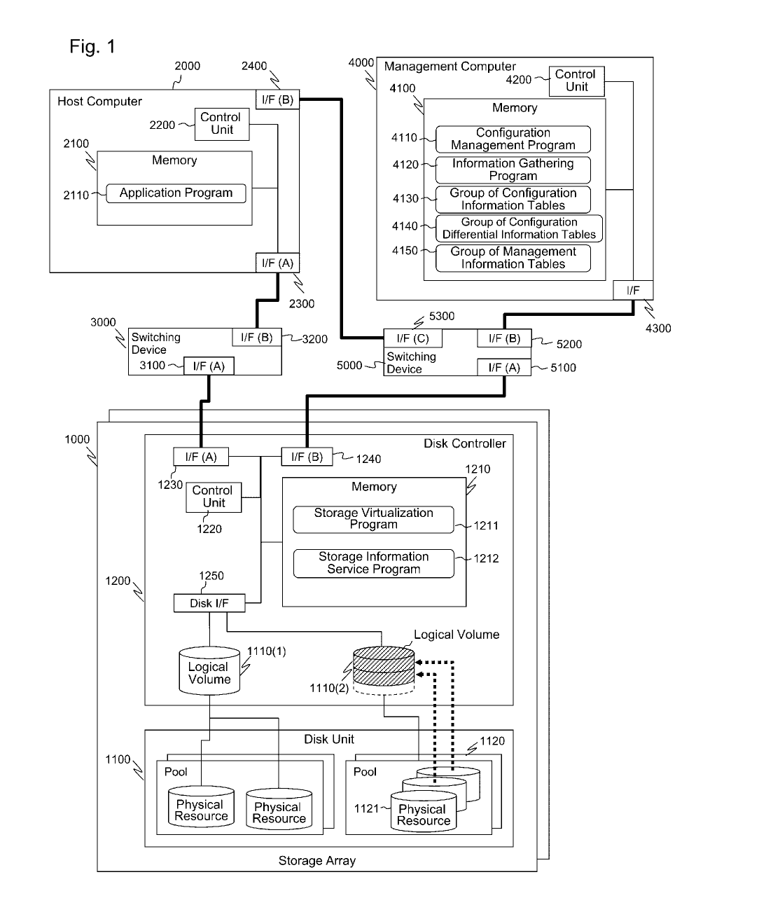

FIG. 1 is an explanatory view showing a configuration of a computer system according to embodiment 1 of the present invention. The present computer system includes a storage array 1000, a host computer 2000, a switching device 3000, a management computer 4000 and a switching device 5000. In the drawing, there are two storage arrays 1000, one host computer 2000, one switching device 3000, one management computer 4000 and one switching device 5000, but the configuration is not restricted thereto, and the number can be one or more.

The storage array 1000 and the host computer 2000 are connected to a network via the switching device 3000. Further, the storage array 1000, the host computer 2000 and the management computer 4000 are connected to the network via the switching device 5000. The switching device 3000 and the switching device 5000 can be identical devices. The switching device 5000 can also be separated into a device for connecting the storage array 1000 and the management computer 2000, and a device for connecting the host computer 2000 and the management computer 4000.

The storage array 1000 includes a disk unit 1100 and a disk controller 1200.

The disk unit 1100 includes physical resources 1121 and pools 1120. Physical resources 1121 refer to resources of storage areas provided via physical devices such as HHDs (Hard Disk Drives) and SSDs (Solid State Drives), and the type of the physical devices providing such resources are not limited. Pools 1120 are a group of physical resources 1121. Generally, pools 1120 are composed by arranging physical resources 1121 in redundant configuration using a technique called RAID (Redundant Array of Independent Disks), but the present invention is not restricted thereto, and any configuration can be adopted as long as one or more physical resources 1121 are formed into a group.

In the drawing, there exist four pools 1120 and five physical resources 1121, but the number can be set to any arbitrary number of one or more. For example, the pool 1120 connected to a logical volume 1110 (1) is formed via RAID configuration, whereas the pool 1120 connected to logical volume 1110 (2) provides a virtual volume via thin provisioning or automated tiering. However, the present invention is not restricted to such example, and both pools can adopt a RAID configuration or both pools can provide virtual volumes.

Furthermore, depending on the hardware specification of the storage array 1000, the pools 1120 providing virtual volumes can be composed of logical volumes 1110 instead of physical resources 1121. In this case, the physical resources 1121 constitute pools 1120 adopting a RAID configuration, and the logical volume 1110 (1) clipped from pools 1120 adopting a RAID configuration constitutes pools 1120 providing virtual volumes, and the logical volume 1110 (2) is clipped from the pools 1120 providing virtual volumes. The configuration of pools 1120 providing virtual volumes is not restricted.

The disk controller 1200 includes a memory 1210, a control unit 1220, an I/F (interface) 1230 for connecting to the switching device 3000, an I/F 1240 for connecting to the switching device 5000, and a disk I/F 1250 for connecting to the disk unit. These components are connected via a bus.

The disk controller 1200 further includes a logical volume 1110. The logical volume 1110 is composed of one or more physical resources, and provided via the disk controller 1200 as a logical storage area to the host computer 2000. The logical volume 1110 (1) is composed of one or more physical resources 1121 allocated in advance, wherein the capacity of the logical volume 1110 (1) is equal to the total capacity of the physical resources 1121 constituting the same. If the physical resource adopts a redundant configuration via RAID, the capacity of the logical volume 1110 (1) may be smaller than the total capacity of the physical resources 1121 constituting the same.

On the other hand, the logical volume 1110 (2) is a virtual logical volume provided to the host computer 2000, wherein based on a write request from the host computer 2000, physical resources 1121 are allocated thereto. Actually, when a write request to data with respect to the logical volume 1110 (2) is received, if a physical resource is not allocated to the target area of the write request, the disk controller 1200 allocates a storage area of the physical resources 1121 to the logical volume 1100 (2), and writes data into the storage area of the physical resource having been allocated. Thus, the storage capacity of the logical volume 1110 (2) provided to the host computer 2000 can be set to a larger capacity than the total capacity of the actually allocated physical resource 1121. The art for realizing such technique is called Thin Provisioning.

Further, if the logical volume 1110 (2) is composed of multiple physical resources 1121, the types of physical devices (such as HDDs and SSDs) being the source providing the physical resources 1121 can differ. The physical resources being the storage destination of the data written into the logical volume 1110 (2) can be varied dynamically via the automated tiering function that the storage array 1000 has, based for example on the access frequency from the host computer 2000. Thereby, for example, it is possible to perform control so that the data having a high access frequency from the host computer 2000 is stored in a physical resource provided from an expensive, high-speed physical media such as the SSD, whereas the data having a low access frequency from the host computer 2000 is stored in a physical resource provided from an inexpensive, low-speed physical media such as the SATA.

In FIG. 1, two types of logical volumes 1110 mentioned above exist one by one, but the present invention is not restricted to such example, and only one of the two types of volumes can be used, or the two types can exist in a mixture, as long as one or more logical volumes 1110 exist.

The memory 1210 stores the program and the data used by the control unit 1220. Especially, the memory 1210 includes a storage virtualization program 1211 and a storage information service program 1212.

The storage virtualization program 1211 is a program for virtualizing the resources (such as the processing performance of the control unit, the memory and the pool) that the storage array 1000 has, and providing the same as a virtual storage array.

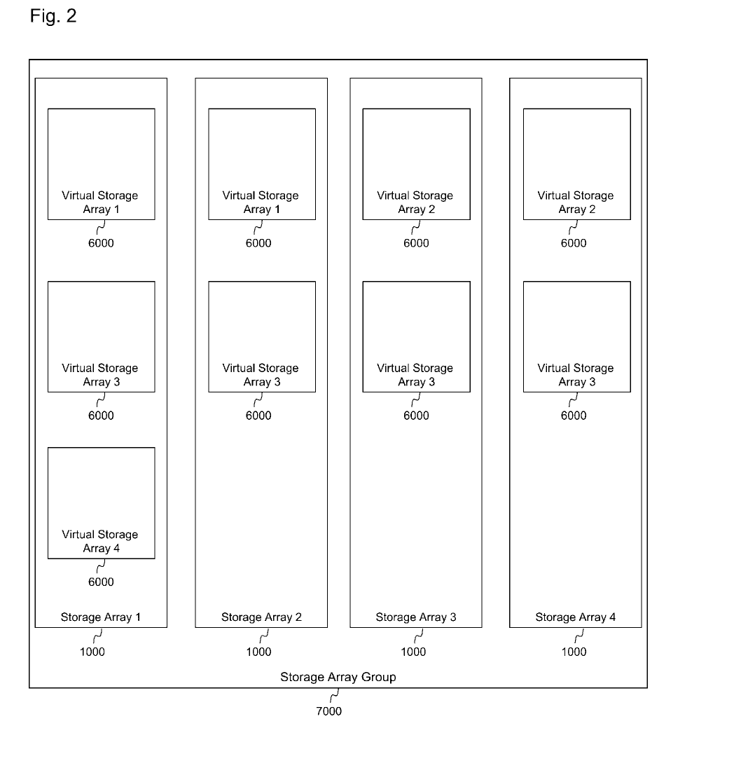

FIG. 2 shows an outline of the configuration of a virtual storage array. In FIG. 2, four virtual storage arrays 6000 are formed on four storage arrays 1000. The four storage arrays 1000 and the four virtual storage arrays 6000 assemble a storage array group 7000. For example, the virtual storage array 1 is constructed in the storage array 1 and storage array 2. The virtual storage array 1 constructed in the storage array 1 and the virtual storage array 1 constructed in the storage array 2 have a common identifier provided thereto, so that the two virtual storage arrays can be recognized as a single storage array from the host computer.

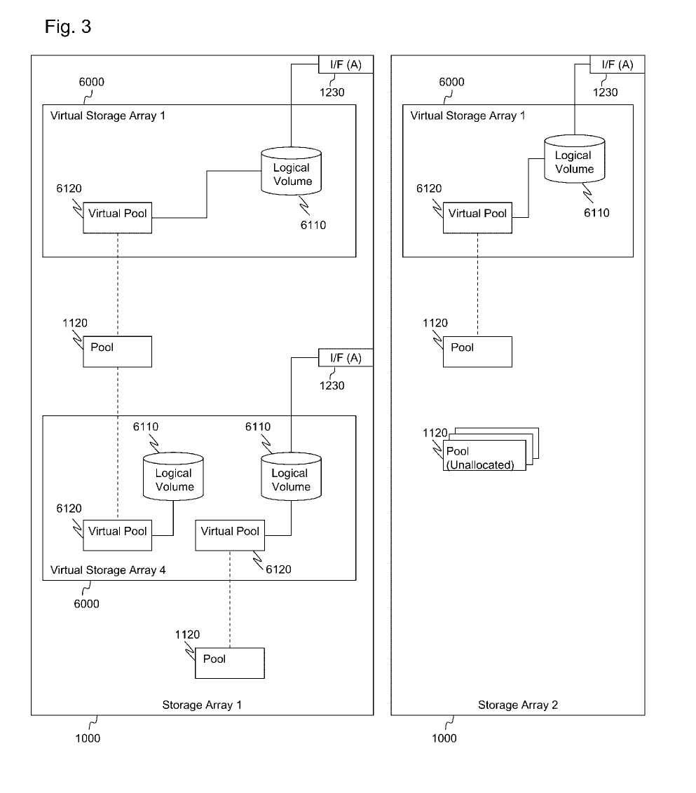

FIG. 3 illustrates the allocation of resources from the storage arrays 1000 to the virtual storage arrays 6000. In FIG. 3, the pools 1120 in the storage arrays 1000 are allocated as virtual pools 6120 included in the virtual storage arrays 6000. The virtual storage arrays 6000 clip storage areas from the virtual pools 6120 as logical volumes 6110. As shown in FIG. 3, a portion of the multiple pools 1120 included in each storage array 1000 can be shared among multiple virtual storage arrays 6000 or may not be allocated to any virtual storage array 6000. Further, FIG. 3 illustrates a state where the pools 1120 in the storage array 1000 are allocated to virtual storage arrays 6000, but it is also possible to virtualize other resources in the storage array 1000 (such as the control unit, the memory, the I/F (A) or the I/F (B)) and allocate the same to virtual storage arrays 6000.

The storage information service program 1212 is a program for gathering the configuration information of the storage array 1000 and transmitting the information to other programs, wherein the program can operate within the memory space of the storage array 1000 or can operate within the memory space of the virtual storage array 6000.

The control unit 1220 can control the execution of programs and input/output of data within the memory 1210, and the input/output of data and control commands via respective I/Fs of the disk controller 1200.

The storage array 1000 has the common functions of a storage array, such as a function to create pools 1120 from physical resources 1121, a function to create a logical volume 1110 from the pools 1120, a function to allocate the logical volume via the I/F (A) 1230 to the host computer 2000, and a function to receive commands to change the configuration or setting of the storage array 1000 from the management computer 4000.

Further, the storage array 1000 can include an input device for allowing the user of the storage array 1000 to enter data, and an output device through which the storage array 1000 provides information to the user, but since they are not directly related to the present invention, they are not shown.

The host computer 2000 has a memory 2100, a control unit 2200, an I/F (A) 2300 for connecting to the switching device 3000, and an I/F (B) 2400 for connecting to the switching device 5000. These components are connected via a bus. The memory 2100 stores the programs and data used by the control unit 2200. Especially, the memory 2100 stores an application program 2110. The application program 2110 can be any program.

The control unit 2200 controls the execution of programs and input/output of data stored in the memory 2100, and controls the input/output of data and control commands through the I/F (A) 2300 and I/F (B) 2400.

The host computer 2000 can further include an input device for allowing the user of the host computer 2000 to enter data, an output device through which the host computer 2000 provides information to the user, and a secondary storage array for storing data and the like, but since they are not directly related to the present invention, they are not shown.

The switching device 3000 has an I/F (A) 3100 for connecting to the storage array 1000 and an I/F (B) 3200 for connecting to the host computer 2000. Network protocols used among the storage array 1000, the host computer 2000 and the switching device 3000 connecting the same include an FC (Fibre Channel) or an iSCSI, but not restricted thereto. Further, a single I/F (A) 3100 and a single I/F (B) 3200 are shown in the drawing, but the number can be one or more.

The management computer 4000 has a memory 4100, a control unit 4200, and an I/F 4300 for connecting to the switching device 5000. The memory 4100 stores programs and data used by the control unit 4200. Especially, the memory 4100 stores a configuration management program 4110, an information gathering program 4120, a group of configuration information tables 4130, a group of configuration differential information tables 4140 and a group of management information tables 4150.

The configuration management program 4110 is a program for managing the configuration of the storage array 1000, especially having a function to gather configuration information of the storage array 1000 via the information gathering program 4120. The configuration management program 4110 further has the common functions of a management computer, such as a function to form pools 1120 from physical resources 1121, a function to create a logical volume 1110 from the pools 1120, a function to allocate the logical volume 1110 via the I/F (A) 1230 to the host computer 2000, and a scheduler function for performing specific processes at specific times. Further, the configuration management program 4110 has a user interface for displaying the configuration information of the storage array 1000 and for allowing management control of the storage array 1000.

The information gathering program 4120 is a program for gathering the configuration information of the storage array 1000, and has a function to acquire the configuration information of the storage array 1000 through communication with a configuration information service program 1211 of the storage array 1000.

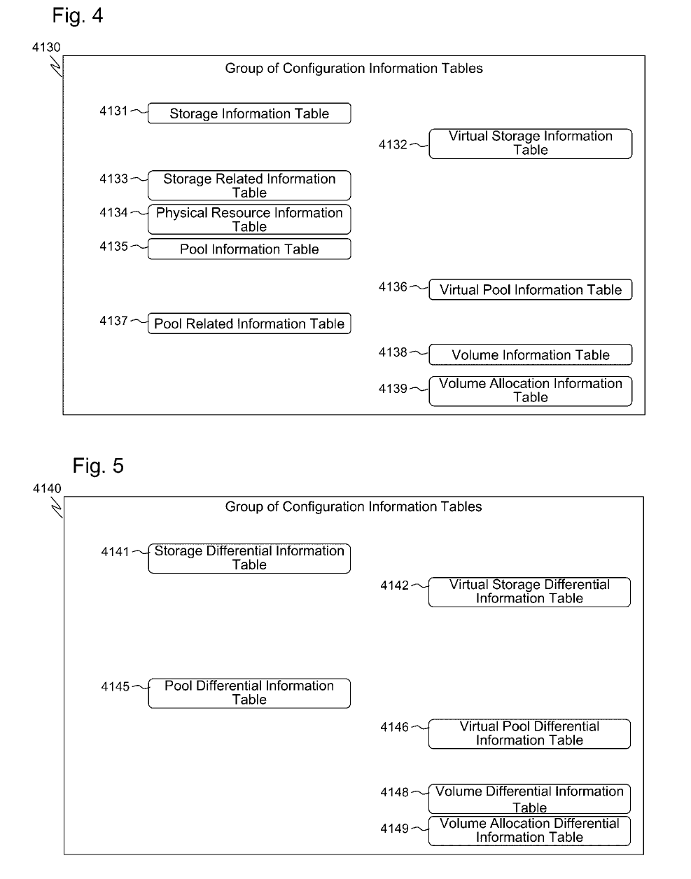

The group of configuration information tables 4130 is a collection of tables storing the configuration information of the storage arrays 1000 and virtual storage arrays 6000, and the actual example thereof is illustrated in FIG. 4. In the present embodiment 1, the group of configuration information tables 4130 is composed of a storage information table 4131, a virtual storage information table 4132, a storage related information table 4133, a physical resource information table 4134, a pool information table 4135, a virtual pool information table 4136, a pool related information table 4137, a volume information table 4138 and a volume allocation information table 4139.

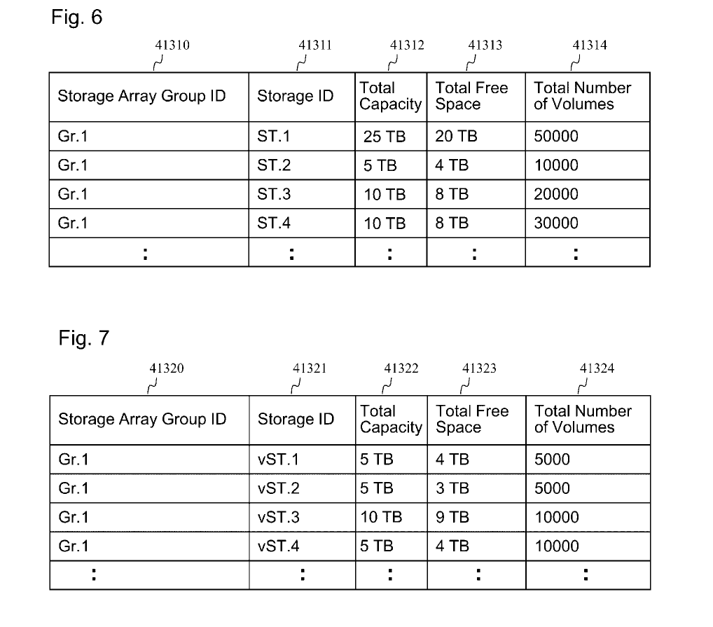

The storage information table 4131 is a table storing the information on the storage arrays 1000, and the actual example thereof is shown in FIG. 6. The storage information table 4131 includes a storage array group ID 41310 for identifying the storage array group 7000 to which the storage array 1000 belongs, a storage ID 41311 for identifying the storage arrays 1000, a total capacity 41312 of pools 1120 included in the storage arrays 1000, a total free space 41313 of pools 1120 included in the storage arrays 1000, and a total number of volumes 41314 which is the total number of the logical volumes 1110 included in the storage arrays 1000. The storage information table 4131 can store not only the information illustrated in FIG. 6 but other information related to the storage arrays 1000.

The virtual storage information table 4132 is a table for storing the information of the virtual storage arrays 6000, and the actual example thereof is illustrated in FIG. 7. The virtual storage information table 4132 includes a storage array group ID 41320 for identifying the storage array group 7000 to which the virtual storage array 6000 belongs, a storage ID 41321 for identifying the virtual storage array 6000, a total capacity 41322 of the virtual pools 6120 included in the virtual storage array 6000, a total free space 41323 of the virtual pools 6120 included in the virtual storage array 6000, and a total number of volumes 41324 which is the total number of the logical volumes 6110 of the virtual storage array 6000. The virtual storage information table 4132 can store not only the information illustrated in FIG. 7 but other information of the virtual storage array 6000.

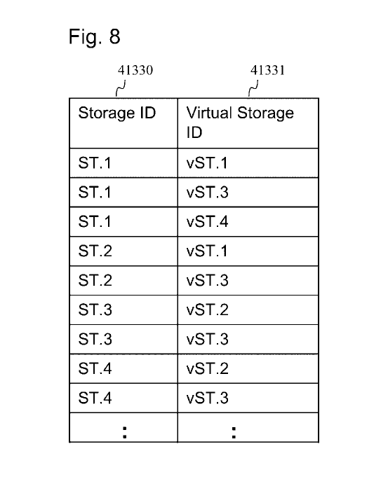

The storage related information table 4133 is a table for storing the information regarding the relationship between the storage array 1000 and the virtual storage array 6000, and the example thereof is illustrated in FIG. 8. The storage related information table 4133 includes a storage ID 41330 for identifying the storage array 1000, and a virtual storage ID 41331 for identifying the virtual storage array 6000. The storage related information table 4133 can store not only the information illustrated in FIG. 8 but other information related to the storage array 1000 and the virtual storage array 6000.

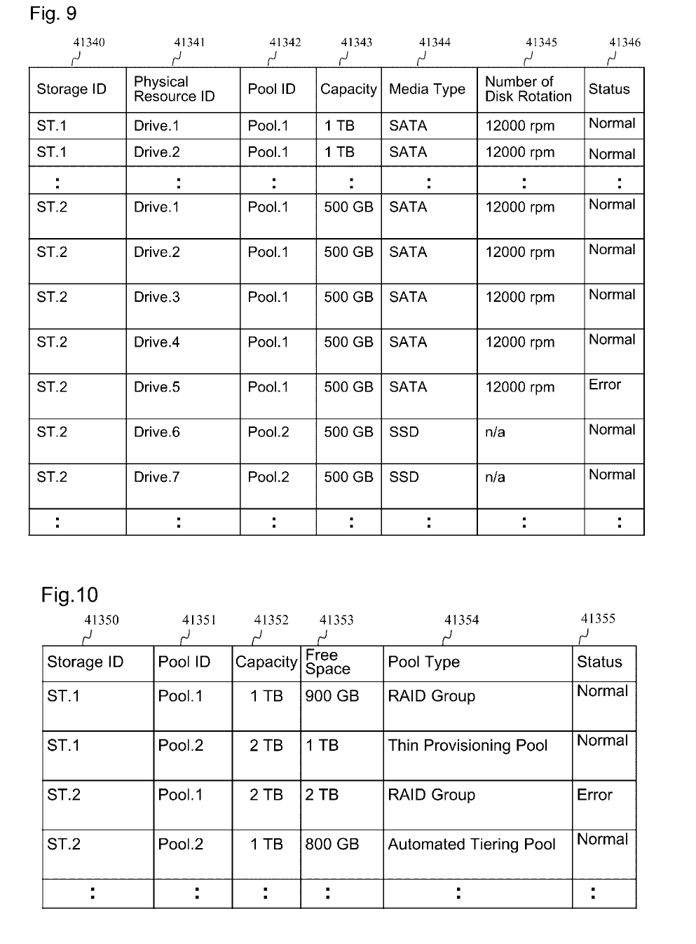

The physical resource information table 4134 is a table for storing the information related to the physical resources 1121 included in the storage arrays 1000, and the actual example thereof is illustrated in FIG. 9. The physical resource information table 4134 includes a storage ID 41340 for identifying the storage array 1000, a physical resource ID 41341 for identifying the physical resources 1121, a pool ID 41342 for identifying the pool 1120 to which the physical resource 1121 is allocated, a capacity 41343 of the physical resource 1121, a media type 41344 illustrating the type of the media being the source of providing the storage area of the physical resource 1121, a number of disk rotation of the media being the source providing the storage area of the physical resource 1121, and the state 41346 of the physical resource 1121.

In FIG. 9, “SATA” or “SSD” is stored as the value in the media type 41344, but the value is not restricted thereto, and any information indicating the media type can be stored therein. In embodiment 1, when the media type 41344 is “SSD”, “n/a” is stored in the number of disk rotation 41345. This shows that the SSD has no disk, and therefore, no disk rotation occurs. There may be other expression methods for indicating that there is no disk rotation. Further, in FIG. 9, either “normal” or “error” is stored in the state 41346, but any information indicating the operation status of the physical resources 1121 can be stored therein. The physical resource information table 4134 can store other information related to the physical resources 1121 in addition to the information illustrated in FIG. 9.

The pool information table 4135 is a table for storing the information related to pools 1120 included in the storage array 1000, and the actual example thereof is illustrated in FIG. 10. The pool information table 4135 includes a storage ID 41350 for identifying the storage array 1000, a pool ID 41351 for identifying the pools 1120, a capacity 41352 of the pools 1120, a free space 41353 of the pools 1120, a pool type 41354 showing the type of the pools 1120, and a status 41355 of the pools 1120.

In FIG. 10, the pool type 41354 stores one of the following values: “RAID group”, “thin provisioning pool” and “automated tiering pool”; but the values are not restricted thereto, and any information indicating the pool type can be stored therein. In embodiment 1, the pools 1120 in which the pool type 41354 is “RAID group” refers to pools in which the capacity of one or more physical resources 1121 can be allocated in advance to the logical volume 1110 (1). Further, the pools 1120 in which the pool type 41354 is “thin provisioning pool” refer to pools in which the physical resources 1121 can be allocated in response to a write request from the host computer 2000 to the logical volume 1110 (2). The pools in which the pool type 41354 is “automated tiering pool” are composed of physical resources provided from multiple types of physical devices, which are pools capable of allocating physical resources 1121 to the logical volume 1110 (2) in response to a write request from the host computer 2000, changing the type of physical resources 1121 allocated to the logical volume 1110 (2) in response for example to the frequency of I/O accesses from the host computer 2000 to the logical volume 1110 (2), and moving the data written into the storage area of the already allocated physical resource 1121 to a storage area of another physical resource 1121. Further according to FIG. 10, a value of either “normal” or “error” is stored in the state 41355, but the values are not restricted thereto, and any information indicating the state of operation of the pools 1120 can be stored therein. Further, the pool information table 4135 can store not only the information illustrated in FIG. 10 but other information related to the pools 1120.

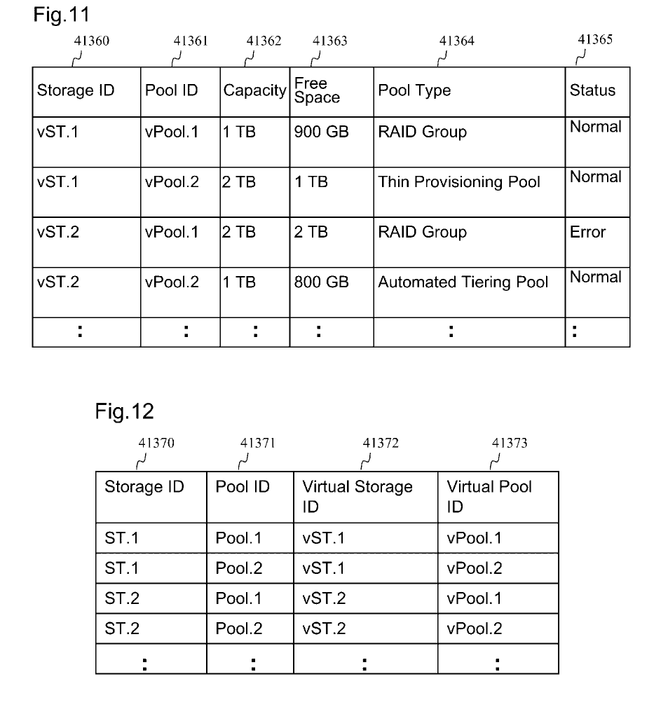

The virtual pool information table 4136 is a table storing the information of virtual pools 6120 in the virtual storage array 6000, the actual example of which is illustrated in FIG. 11. The virtual pool information table 4136 includes a storage ID 41360 for identifying the virtual storage array 6000, a pool ID 41361 for identifying the virtual pool 6120, a capacity 41362 of the virtual pool 6120, a free space 41363 of the virtual pool 6120, a pool type 41364 for showing the type of the virtual pool 6120, and a state 41365 of the virtual pool 6120.

In FIG. 11, one of the following values; “RAID group”, “thin provisioning pool” and “automated tiering pool”; is stored in the pool type 41364, but any information showing the pool type can be stored therein. The meanings of “RAID group”, “thin provisioning pool” and “automated tiering pool” indicating the pool type 41364 in FIG. 11 are the same as the meanings described in the description of the pool type 41354 of the pool information table 4135. Further, in FIG. 11, “normal” or “error” is stored in the state 41365, but any information indicating the operation status of the virtual pool 6120 can be stored therein. The virtual pool information table 4136 can store not only the information illustrated in FIG. 11 but other information of the virtual pools 6120.

The pool related information table 4137 stores the relationship information between the pools 1120 included in the storage array 1000 and the virtual pools 6120 included in the virtual storage array 6000, and the actual example thereof is illustrated in FIG. 12. The pool related information table 4137 includes a storage ID 41370 for identifying the storage array 1000, a pool ID 41371 for identifying the pool 1120 included in the storage array 1000, a virtual storage ID 41372 for identifying the virtual storage array 6000, and a virtual pool ID 41373 for identifying the virtual pool 6120 included in the virtual storage array 6000. The pool related information table 4137 can store other information related to the relationship between the pools included in the storage array 1000 and the virtual pools 1120 included in the virtual storage array 6000 in addition to the information shown in FIG. 12.

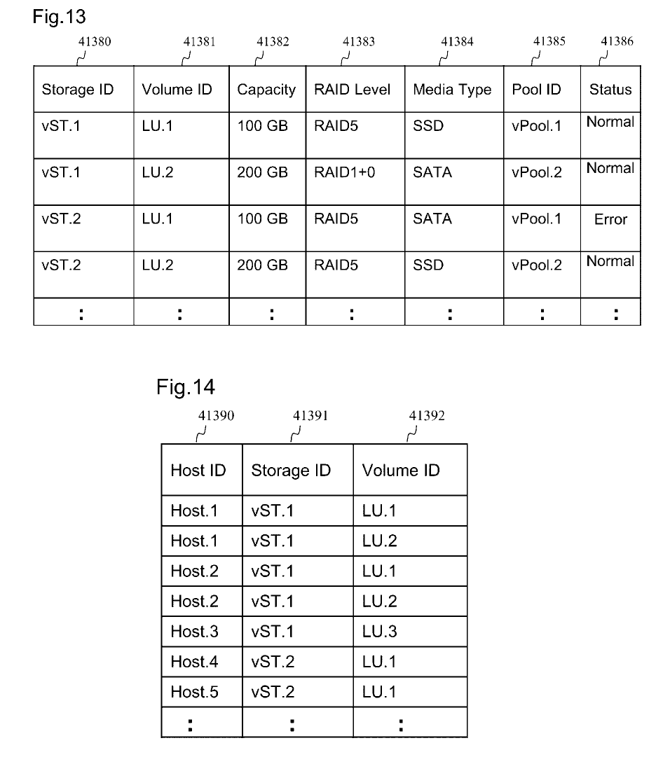

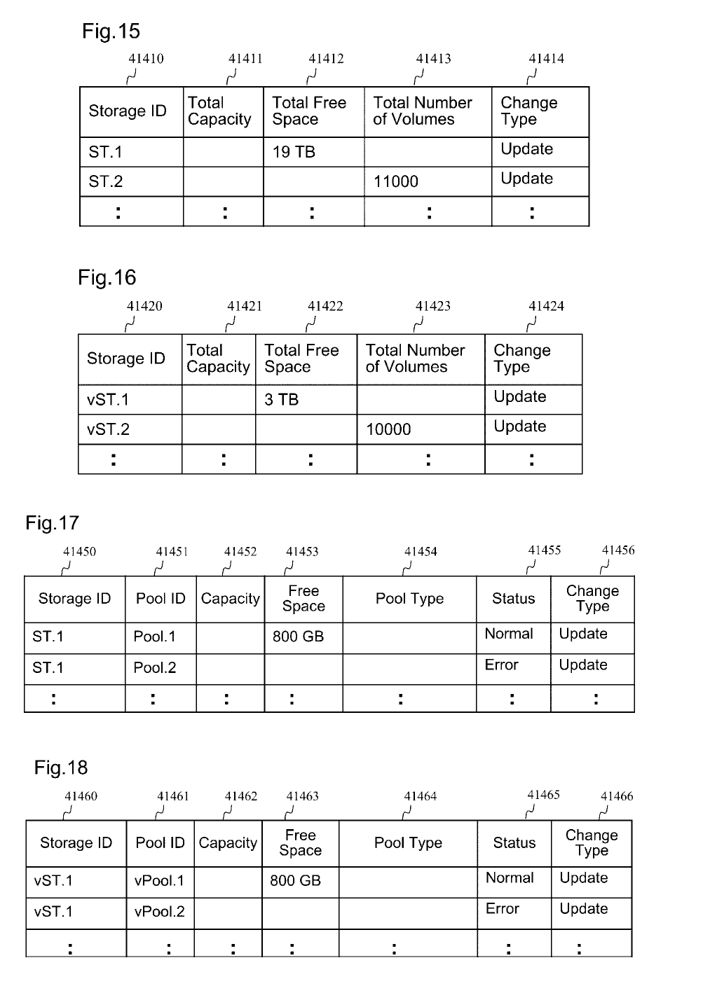

The volume information table 4138 is a table storing the information related to the logical volume 6110 included in the virtual storage array 6000, and the actual example thereof is illustrated in FIG. 13. The volume information table 4138 includes a storage ID 41380 for identifying the virtual storage array 6000, a volume ID 41381 for identifying the logical volume 6110, a capacity 41382 of the logical volume 6110, a RAID level 41383 of the logical volume 6110, a media type 41384 of the physical resource 1121 which is the source providing the storage area of the logical volume 6110, a pool ID 41385 for identifying the virtual pool 6120 which is the source from which the logical volume 6110 is clipped, and a state 41386 of the logical volume 6110.

Now, the RAID level refers to the information showing the type of the RAID technology applied to the virtual pool 6120 being the source from which the logical volume 6110 is clipped, that is, the information showing the level of redundancy of the logical volume 6110. Further, the state 41386 is the information showing the operation status of the logical volume 6110. In FIG. 13, either “normal” or “error” is stored in the state 41386, but any information showing the operation status of the logical volume 6110 can be stored therein. Further, the volume information table 4138 can store not only the information illustrated in FIG. 13 but other information related to the logical volume 6110. Furthermore, the volume information table 4138 can store information of the logical volume 1110 stored in the storage array 1000.

The volume allocation information table 4139 is a table showing the relationship between the host computer 2000 and the logical volume 6110 allocated to the host computer 2000, and the actual example thereof is illustrated in FIG. 14. The volume allocation information table 4139 includes a host ID 41390 for identifying the host computer 2000, a storage ID 41391 for identifying the storage array 6000, and a volume ID 41392 for identifying the logical volume 6110. The volume allocation information table 4139 can store not only the information shown in FIG. 14 but also other information related to the relationship between the host computer 2000 and the logical volume 6110 allocated to the host computer 2000. Further, the volume allocation information table 4139 can store the information showing the relationship between the host computer 2000 and the logical volume 1110 allocated to the host computer 2000.

The above description has explained the respective tables constituting the group of configuration information tables 4130.

The group of configuration differential information tables 4140 is an assembly of tables storing changed information as differential information when a management operation accompanying the change of configuration is executed related to the configuration of the storage array 1000 and the virtual storage array 6000 when the configuration management program 4110 is updating the information stored in the group of configuration information tables 4130. In embodiment 1, the group of configuration differential information tables 4140 includes a storage differential information table 4141, a virtual storage differential information table 4142, a pool differential information table 4145, a virtual pool differential information table 4146, a volume differential information table 4148 and a volume allocation differential information table 4149.

The configurations of the tables are basically respectively the same as the storage information table 4131, the virtual storage information table 4132, the pool information table 4135, the virtual pool information table 4136, the volume information table 4138 and the volume allocation information table 4139. The difference is that the tables constituting the group of configuration differential information tables 4140 include an attribute of change type. The change type is the information showing the type of the change that has occurred with respect to the configuration of the storage array 1000 and the virtual storage array 6000.

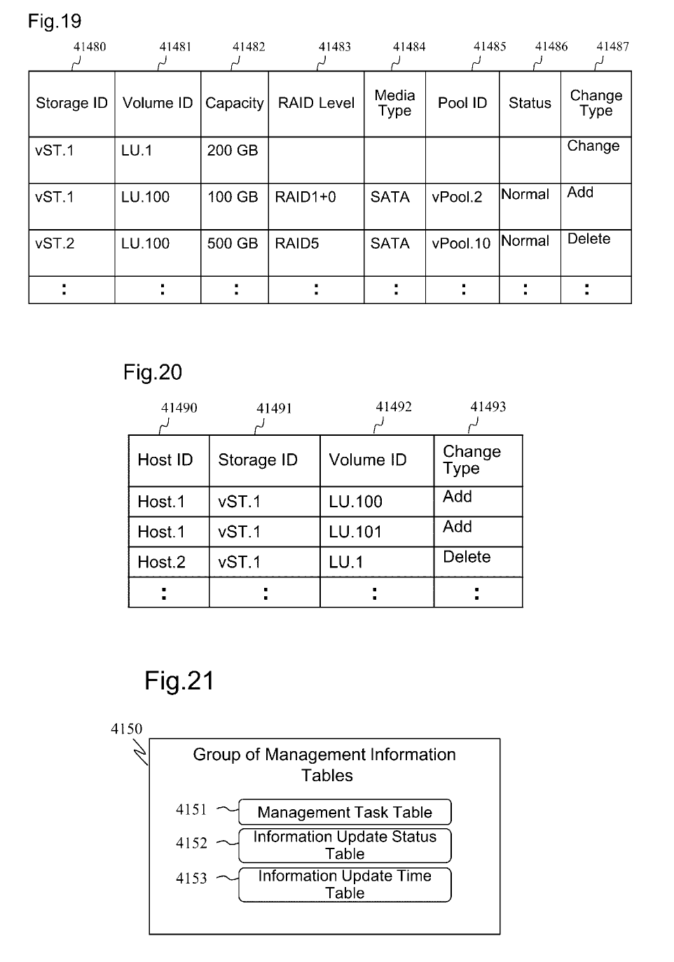

In present embodiment 1, a value selected from “add”, “update” and “delete” is stored in the change type. For example, in the volume differential information table 4148 shown in FIG. 19, a record having “vST.1” stored in the storage ID 41480 and “LU.1” stored in the volume ID 41481 has “200 GB” stored in the capacity 41482 and “change” stored in the change type 41487. This shows that the capacity of the corresponding logical volume 6110 has been changed (expanded) to 200 GB. In embodiment 1, when the change type is “update”, each of the tables constituting the group of configuration differential information tables 4140 only store values related to the changed attribute.

Further, regarding the volume differential information table 4148, the record having “vST.1” stored in the storage ID 41480 and “LU.100” stored in the volume ID 41481 has “add” stored in the change type 41487. This indicates that the corresponding logical volume 6110 has been added. Moreover, in the volume differential information table 4148, the record having “vST.2” stored in the storage ID 41480 and “LU.100” stored in the volume ID 41481 has “delete” stored in the change type 41487. This indicates that the corresponding logical volume 6110 has been deleted.

The other tables constituting the group of configuration differential information tables 4140 will not be described here. The above description has illustrated the group of configuration differential information tables 4140.

The group of management information tables 4150 is an assembly of tables storing the management information used for the configuration management program 4110 to manage the configuration of the storage array 1000 and the virtual storage array 6000, and the actual example thereof is illustrated in FIG. 21. In the present embodiment 1, the group of management information tables 4150 is composed of a management task table 4151, an information update status table 4152 and an information update time table 4153.

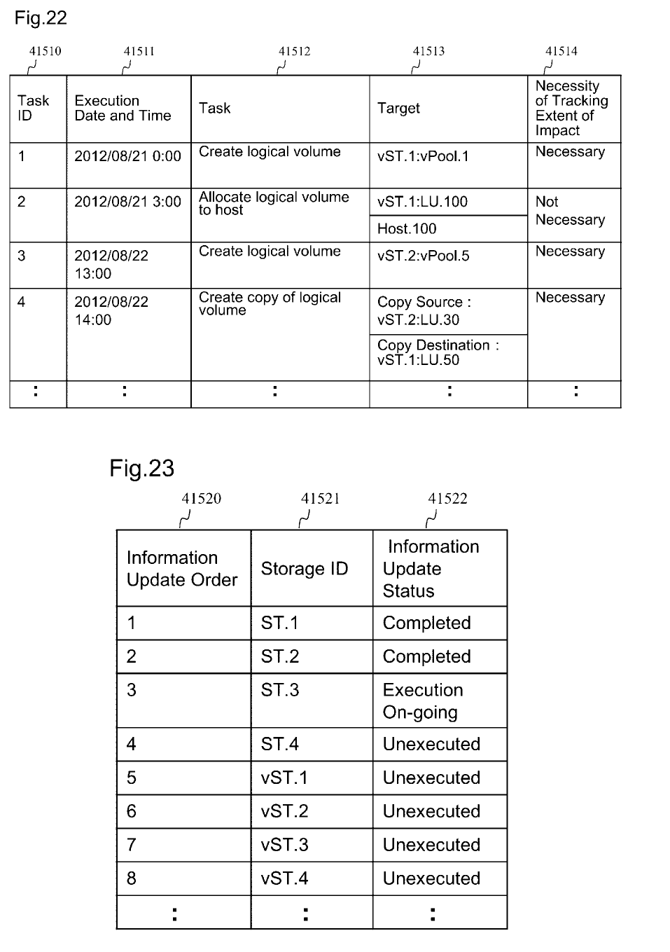

The management task table 4151 is a table for storing the information on the management task executed by the configuration management program 4110, and the actual example thereof is illustrated in FIG. 22. The management task table 4151 includes a task ID 41510 for identifying the management task, an execution date and time 41511 of the management task, a task 41512 indicating the management task, a target 41513 indicating the execution target resource of the management task, and a necessity of tracking extent of impact 41514 indicating whether it is necessary to track the extent of impact caused by changing the configuration occurring as a result of executing the management task in the information update processing of the storage array described later. In FIG. 22, a management task described via a natural language is stored in the task 41512, but any information denoting the management task can be stored therein. Further in FIG. 22, a value having added the ID of the resource being the target of execution of the management target via a “:” is stored in the target 41513, but any information capable of identifying the execution target resource of the management target can be stored therein.

The information update status table 4152 is a table showing the status of progress of processing when the configuration management program 4110 updates the configuration information of the storage array 1000 and the virtual storage array 6000, and the actual example thereof is shown in FIG. 23. The information update status table 4152 includes an information update order 41520 showing the order for executing the update of information, a storage ID 41521 for identifying the storage array 1000 or the virtual storage array 6000 being the target of update of information, and an information update status 41522 showing the status of progress of the information update. In the present embodiment 1, the information update status 41522 stores a value selected from “unexecuted”, “execution on-going” and “completed”, but any information showing the status of progress of update of the information can be stored therein.

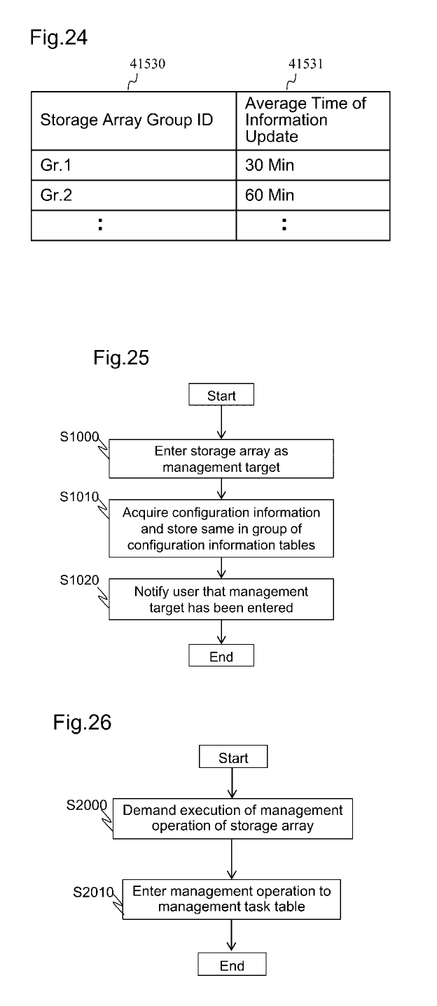

The information update time table 4153 is a table showing the estimate of the time required for the configuration management program 4110 to update the configuration information of all the storage arrays 1000 and virtual storage arrays 6000 included in the storage array group 7000, and the actual example thereof is illustrated in FIG. 24. The information update time table 4153 includes an average time 41531 for updating information showing the estimated time required for updating the configuration information of all the storage arrays 1000 and the virtual storage arrays 6000 included in the storage array group 7000 and the storage array group ID 41530 for identifying the storage array group 7000. In the present embodiment 1, the average time 41531 for updating information stores an average of the time required for information update executed in the past, but any information showing the estimated time required for updating information in the storage array group 7000 can be stored therein. The above description has illustrated the group of management information tables 4150.

The control unit 4200 controls execution of programs and input/output of data within the memory 4100, and the control of input/output of data and control commands through the I/F 4300.

The management computer 4000 can further include an input device for allowing a user to input data to the management computer 4000, an output device for providing information to the user of the management computer 4000, and a secondary storage array for storing data. Further, the various tables stored in the management computer 4000 can be stored not only in the memory but in a secondary storage array.

In FIG. 1, the management computer 4000 and the storage array 1000 are illustrated as independent devices, but it is also possible to have the management computer 4000 exist within the same chassis as the storage array 1000. Moreover, by storing the program within the memory 4100 of the management computer 4000 in the memory 1210 of the storage array 1000 and executing the program via the control unit 1220, a similar function as the management computer 4000 can be realized. Further, the management computer 4000 can store programs for managing the switching device 3000 and the switching device 5000.

The switching device 5000 includes an I/F (A) 5100 for connecting to the storage array 1000, an I/F (B) 5200 for connecting to the management computer 4000, and an I/F (C) 5300 for connecting to the host computer 2000. One example of the network protocols used among the storage array 1000, the management computer 4000, the host computer 2000 and the switching device 5000 coupled thereto is a TCP/IP, but the protocol is not restricted thereto. In the drawing, the number of I/F (A) 5100, I/F (B) 5200 and I/F (C) 5300 are one each, but the number can be greater.

### A2. Description of Data Processing Sequence

The data processing sequence according to present embodiment 1 will be described.

FIG. 25 illustrates a processing sequence according to embodiment 1 where the configuration management program 4110 enters the storage array 1000 and the virtual storage array 6000 as the management target.

In the present processing, at first in step S1000, the administrator (user) of the storage array group 7000 requests to enter the storage array 1000 and the virtual storage array 6000 as the management target of the configuration management program 4110 via the user interface of the configuration management program 4110. Since the user does not know the configuration of the virtual storage array 6000 formed in the storage array 1000 at this point of time, the target designated to be entered as the management target is the storage array 1000.

Next, in step S1010, the configuration management program 4110 demands the information gathering program 4120 to collect the configuration information from the storage array 1000 designated by the user in step S1000. The information gathering program 4120 collects the configuration information by communicating with the storage information service program 1212 of the storage array 1000, and stores the collected configuration information in the group of configuration information tables 4130. At this time, if a virtual storage array 6000 is formed in the storage array 1000, the configuration information of the virtual storage array 6000 will also be collected and stored.

Further in step S1030, the configuration management program 4110 notifies the user that the storage array 1000 and the virtual storage array 6000 have been entered as the management target. The notification methods include, but are not limited to, methods using user interfaces such as GUI (Graphical User Interface) and CLI (Command Line Interface), or a method for outputting a message via a log.

By the above-described processing, the process for registering the storage array 1000 and the virtual storage array 6000 as the management target of the configuration management program 4110 is completed. The present processing is not necessarily executed by having the user enter the storage array 1000 as the management target of the configuration management program 4110. That is, the registration processing can be executed for example when the configuration management program 4110 detects the presence of the storage array 1000 connected through the switching device 5000 using techniques such as an SLP (Service Location Protocol).

FIG. 26 shows a sequence of the processing for entering a management operation to the configuration management program 4110 when the administrator of the storage array group 7000 and the administrator of the virtual storage array 6000 demands execution of management operation of the storage array 1000 and the virtual storage array 6000 via the user interface of the configuration management program 4110.

In the present processing, at first in step S2000, the user demands execution of management operation of the storage array 1000 and the virtual storage array 6000 via the user interface of the configuration management program 4110.

In step S2010, the configuration management program 4110 enters the management operation of the storage array 1000 and the virtual storage array 6000 to the management task table 4151.

According to the above processing, the process for entering the management operation of the storage array 1000 and the virtual storage array 6000 to the configuration management program 4110 is completed. If the user wishes to immediately execute the management operation of the storage array 1000 and the virtual storage array 6000, the current date and time should be designated as the execution date and time of the management task.

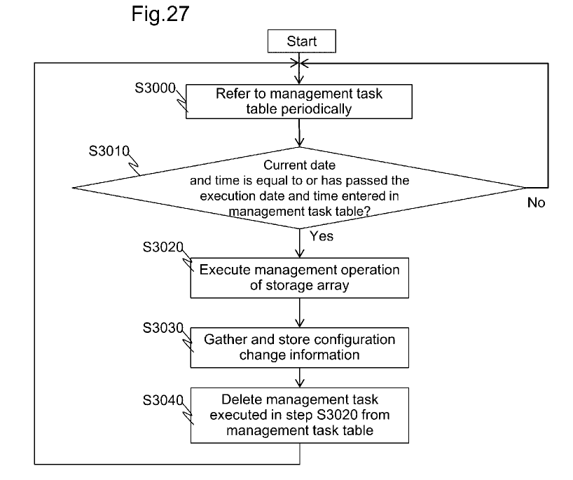

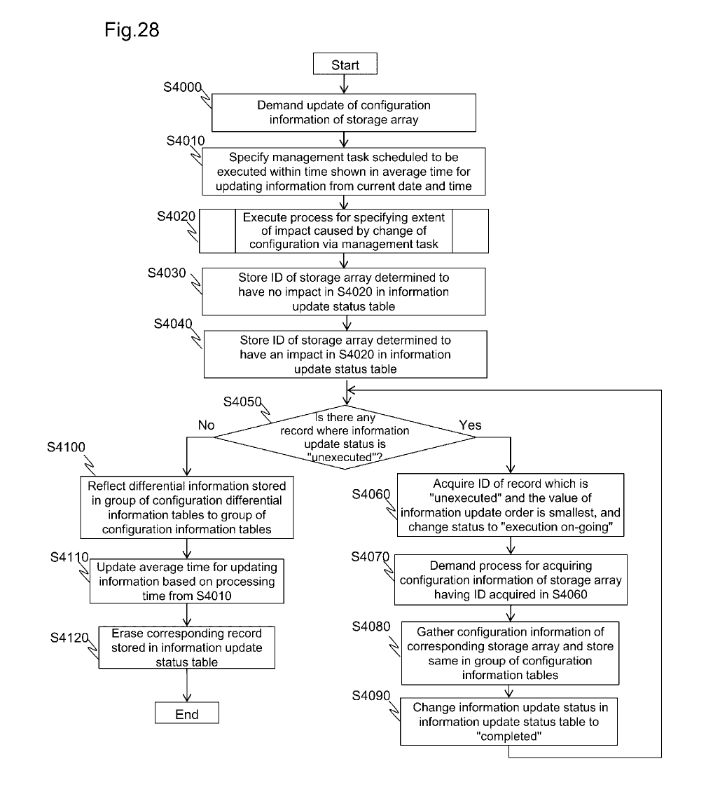

FIG. 27 illustrates a sequence of processing according to embodiment 1 when the configuration management program 4110 executes the management operation of the storage array 1000 and the virtual storage array 6000. In the present embodiment 1, the processing of FIG. 27 is executed via an independent thread as the other processes (such as the process of FIG. 28). That is, the process of FIG. 27 is executed in parallel with other processes.

In the present processing, at first in step S3000, the configuration management program 4110 periodically refers to the management task table 4151. The interval of the time of the configuration management program 4110 referring to the management task table 4151 can either be determined in advance or designated by the user.

Next, in step S3010, the configuration management program 4110 compares the current date and time with the execution date and time 41511 entered in the management task table 4151, and determines whether the current date and time is equal to or has passed the execution date and time 41511 entered in the management task table 4151.

If the current date and time is not equal to the execution date and time 41511 entered in the management task table 4151 and has not yet passed the entered date and time, the procedure advances to step S3000, whereas if the current date and time is equal to or has passed the execution date and time 41511, the procedure advances to step S3020.

Next, in step S3020, the configuration management program 4110 executes a management task (management operation) of the storage array 1000 and the virtual storage array 6000. Possible management tasks (management operations) include, but are not restricted to, an operation for allocating pools 1120 as virtual pools 6120, an operation for creating a logical volume 6110 from virtual pools 6120, and an operation for allocating the logical volume 6110 to the host computer 2000, as shown partially in the task 41512 of the management task table 4151.

Next, in step S3030, the information gathering program 4120 collects the configuration information of the storage array 1000 and the virtual storage array 6000 changed via the management task executed in step S3020, and stores the same in the group of configuration information tables 4130.

Thereafter, in step S3040, the configuration management program 4110 deletes the management task executed in step S3020 from the management task table 4151. When the deleting process is ended, the procedure returns to step S3000.

By the processes described above, the process for executing the management operation to the storage array 1000 and the virtual storage array 6000, and the process of reflecting the configuration of the storage array 1000 and the virtual storage array 6000 changed via the management operation in the group of configuration information tables 4130 are completed.

FIG. 28 shows a sequence of the process of the configuration management program 4110 for updating the configuration information of the storage array 1000 and the virtual storage array 6000 included in the storage array group 7000 according to embodiment 1.

In the present processing, at first in step S4000, the administrator (user) of the storage array group 7000 demands update of the configuration information of the storage array 1000 and the virtual storage array 6000 included in the storage array group 7000 via the user interface of the configuration management program 4110.

Next, in step S4010, the configuration management program 4110 refers to the management task table 4151 and the information update time table 4153, and specifies the management task being scheduled to be executed within the time indicated in the average time 41531 for updating information from the current date and time.

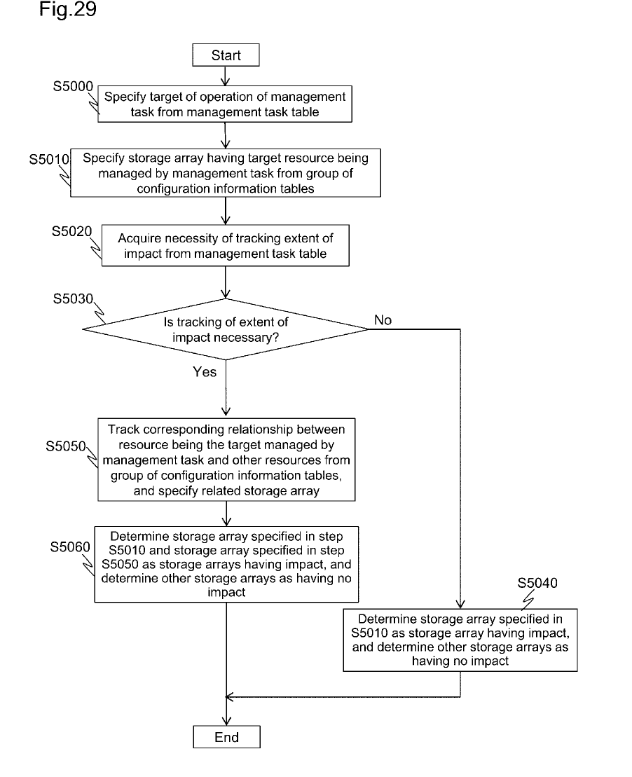

Next, in step S4020, the configuration management program 4110 executes a process for specifying the extent of impact of changing the configuration caused as a result of executing the management task specified in step S4010. The contents of the present processing will be described in detail later with reference to FIG. 29.

Next, in step S4030, the configuration management program 4110 stores the storage ID (identifier) of the storage array 1000 or the virtual storage array 6000 determined to have no impact in step S4020 in the information update status table 4152. At this time, “unexecuted” is stored in the information update status 41522. If multiple storage arrays 1000 or virtual storage arrays 6000 determined to have no impact in step S4020 exist, the order for updating information among the storage arrays 1000 or virtual storage arrays 6000 can be determined for example by setting the order of the storage array 1000 to come after the virtual storage array 6000, or to set the order so that the storage array 1000 or the virtual storage array 6000 having the greater number of resources (logical volumes and pools) is updated first.

Next, in step S4040, the configuration management program 4110 stores the storage ID (identifier) of the storage array 1000 or the virtual storage array 6000 determined to have an impact in step S4020 in the information update status table 4152. At this time, “unexecuted” is stored in the information update status 41522. If multiple storage arrays 1000 or virtual storage arrays 6000 determined to have an impact in step S4020 exist, the order for updating information among the storage arrays 1000 or virtual storage arrays 6000 can be determined for example by setting the storage array 1000 or virtual storage array 6000 having the earliest execution date and time of the management time at the top of the execution sequence of updating information.

Through the processes of steps S4030 and S4040, the information update status table 4152 stores records so that the order of the storage array 1000 or the virtual storage array 6000 determined to have no impact in step S4020 is set earlier in the order for updating information than the storage array 1000 or the virtual storage array 6000 determined to have an impact in step S4020. Thus, by updating information of the storage array 1000 or the virtual storage array 6000 known to cause change of configuration via the scheduled management task at a later timing, it becomes possible to minimize the occasion where configuration change occurs during update of information.

Next, it is determined in step S4050 whether a record in which the information update status 41522 is “unexecuted” exists in the information update status table 4152 or not. If a corresponding record exists, the procedure advances to step S4060, and if a corresponding record does not exist, the procedure advances to step S4100.

In step S4060, the configuration management program 4110 refers to the information update status table 4152, specifies a single record where the information update status 41522 is “unexecuted” and the value of the information update order 41520 is smallest, so as to acquire the storage ID 41521 and to change the information update status 41522 to “execution on-going”.

Next, in step S4070, the configuration management program 4110 demands the information gathering program 4120 to execute the process for acquiring configuration information with respect to the storage array 1000 or the virtual storage array 6000 shown in the storage ID 41521 acquired in step S4060.

Next, in step S4080, the information gathering program 4120 gathers the configuration information of the storage array 1000 or the virtual storage array 6000, and stores the same in the group of configuration information tables 4130.

Thereafter, in step S4090, the configuration management program 4110 refers to the information update status table 4152, and changes the information update status 41522 of the record corresponding to the storage ID 41521 acquired in step S4060 to “completed”. When the process of step S4090 is completed, the procedure returns to step S4050.

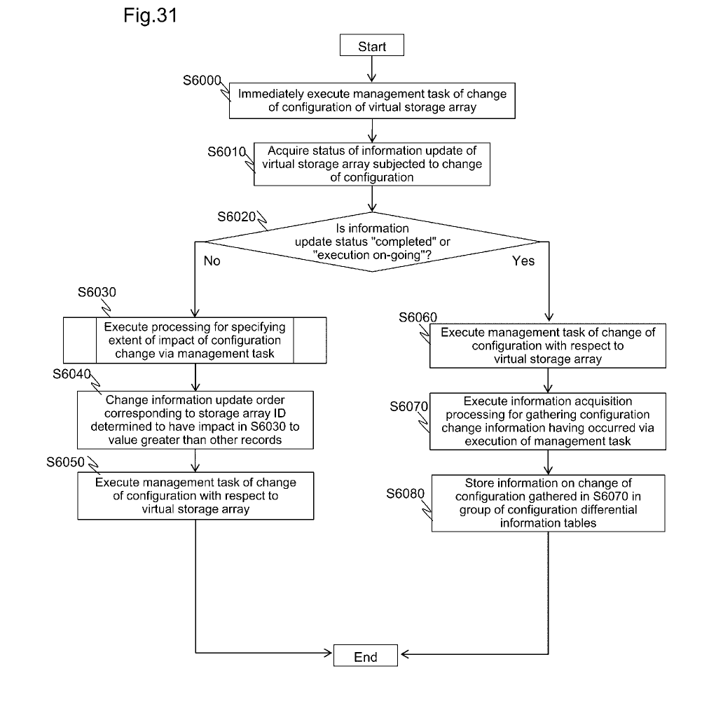

On the other hand, in step S4100, when differential information is stored in the group of configuration differential information tables 4140, the configuration management program 4110 reflects the information to the group of configuration information tables 4130. The differential information having been reflected is deleted from the group of configuration differential information tables 4140. Further, the process for storing the differential information in the group of configuration differential information tables 4140 will be described later with reference to FIG. 31.

Next, in step S4110, the configuration management program 4110 refers to the average time 41531 for updating information in the information update time table 4153, re-calculates the average value based on the average time 41531 and the time required to perform processes of steps S4010 to S4110, and updates the average time 41531 for updating information.

Next, in step S4120, the configuration management program 4110 erases the corresponding record stored in the information update status table 4152.

Based on the above-described processes, the process of the configuration management program 4110 updating the configuration information of the storage array 1000 and the virtual storage array 6000 included in the storage array group 7000 is completed.

FIG. 29 illustrates a sequence of the process for specifying the extent of impact of the change of configuration that occurs as a result of executing the management task by the configuration management program 4110 in embodiment 1. According to present embodiment 1, the process illustrated in FIG. 29 is invoked by step S4020 of the process illustrated in FIG. 28 and step S6030 of the process illustrated in FIG. 31 described later.

In the present process, at first in step S5000, the configuration management program 4110 refers to the management task table 4151, and specifies the target 41513 manipulated via the management task.

Next, in step S5010, the configuration management program 4110 refers to the group of configuration information tables 4130, and specifies the storage array 1000 or the virtual storage array 6000 having the ownership of the target resource being manipulated by the management task.

Next, in step S5020, the configuration management program 4110 refers to the management task table 4151, and acquires the value of the necessity of tracking extent of impact 41514.

Then, in step S5030, the configuration management program 4110 determines whether tracking of the extent of impact is necessary or not. If tracking of the extent of impact is necessary, the procedure advances to step S5050, and if tracking of the extent of impact is not necessary, the procedure advances to S5040.

In step S5040, the configuration management program 4110 determines that the storage array 1000 or the virtual storage array 6000 specified in step S5010 is a storage array having impact, and determines that the other storage array 1000 or the virtual storage array 6000 included in the storage array group 7000 is a storage array not having impact.

In step S5050, the configuration management program 4110 refers to the group of configuration information tables 4130, tracks the corresponding relationship between the resource being the target being manipulated by the management task and other resources, and specifies the related storage array 1000 or the virtual storage array 6000.

Next, in step S5060, the configuration management program 4110 determines the storage array 1000 or the virtual storage array 6000 specified in step S5010 and the storage array 1000 or the virtual storage array 6000 specified in step S5050 as storage systems having impact, and determines the other the storage arrays 1000 or virtual storage arrays 6000 as storage arrays not having impact.

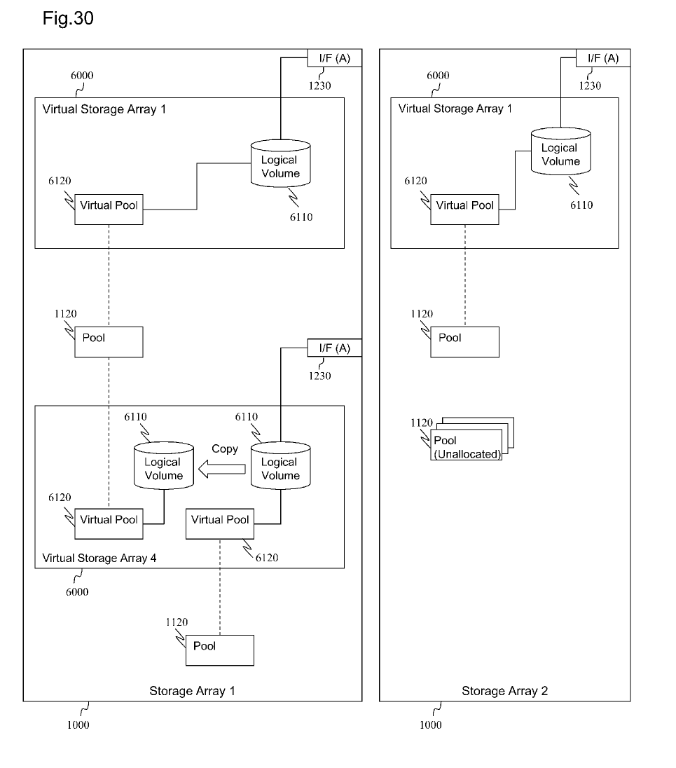

Now, the extent of impact of the change of configuration that has occurred as a result of executing the management task will be described taking the configuration illustrated in FIG. 30 as an example. The configuration illustrated in FIG. 30 is similar to the configuration illustrated in FIG. 3. Here, we will assume that a management task in which the value of the task ID 41510 is “4” in the management task table 4151 is executed. Further, we will assume that the logical volume being the target of creating a copy via the management task is a logical volume included in the virtual storage array 4 of FIG. 30. At this time, the configuration management program 4110 specifies the virtual storage array 4 in step S5010. The management task in which the value of the task ID 41510 is “4” in the management task table 4151 has the value “necessary” stored in the necessity of tracking extent of impact 41514, so that the configuration management program 4110 moves on to step S5050. In step S5050, the configuration management program 4110 tracks resources (such as virtual pools and pools) related to the copy source logical volume and copy destination logical volume, and specifies the storage array 1 and the virtual storage array 1 as related storage arrays. Then, in step S5060, the configuration management program 4110 determines the storage array 1, the virtual storage array 1 and the virtual storage array 4 as storage arrays having impact.

As for the virtual storage array 1, only the area constructed in the storage array 1 is specified as the related storage array, and the area of the virtual storage array 1 constructed in the storage array 2 can be specified as an unrelated storage array. At this time, upon storing a record showing the information update status of the virtual storage array 6000 to the information update status table 4152, it is necessary to store records corresponding to the respective areas of the virtual storage array 6000 considering the relationship with the physical storage array 1000.

According to the above-described process, the process of the configuration management program 4110 specifying the extent of impact of the change of configuration occurring as a result of executing the management task is completed.

FIG. 31 illustrates a sequence of the process where the management operation accompanying the change of configuration has been executed to the virtual storage array 6000 by the administrator of the virtual storage array 6000 during update of the configuration information of the storage array 1000 and the virtual storage array 6000 included in the storage array group 7000 by the configuration management program 4110 according to embodiment 1.

In the present processing, at first in step S6000, the administrator of the virtual storage array 6000 executes a management operation accompanying a change of configuration with respect to the virtual storage array 6000 via the user interface of the configuration management program 4110. Further, in present embodiment 1, it is assumed that the administrator of the virtual storage array 6000 immediately executes the management operation.

However, by other reasons, the process of S6010 and subsequent steps can be performed when a management task other than the management task specified in step S4010 is executed during execution on-going of the information update processing illustrated in FIG. 28. As an example of such condition, for example, the process of executing the information update processing illustrated in FIG. 28 may take up a longer time than the time shown in the average time 41531 for updating information in the information update time table 4153, so that the execution of a scheduled management task that differs from the management task specified in step S4010 may be started. In another example, a new management task may be entered after the execution of step S4010 has been completed, and the execution date and time of the task is set within the execution period of the information update processing.

Next, in step S6010, the configuration management program 4110 refers to the information update status table 4152, and acquires the value of the information update status 41522 of the virtual storage array 6000 subjected to change of configuration.

Next, in step S6020, the configuration management program 4110 determines whether the information update status is “completed” or “execution on-going”. If the information update status is “completed” or “execution on-going”, the procedure advances to step S6060. If the information update status is not “completed” or “execution on-going” (in other words, if the information update status is “unexecuted”), the procedure advances to step S6030.

In step S6030, the configuration management program 4110 executes the specific processing of the extent of impact via the management task. The content of the processing is as shown in FIG. 29.

Next in step S6040, the configuration management program 4110 refers to the information update status table 4152, and changes the information update order 41520 of the record corresponding to the ID of the storage array 1000 or the virtual storage array 6000 determined to have an impact in step S6030 to a value greater than the information update order of other records. In other words, the order of information update of the corresponding storage array 1000 or the virtual storage array 6000 is changed to be later than the other storage arrays 1000 or virtual storage arrays 6000.

Then, in step S6050, the configuration management program 4110 executes a management task of the change of configuration with respect to the virtual storage array 6000.

On the other hand, in step S6060, the configuration management program 4110 executes a management task of the change of configuration with respect to the virtual storage array 6000.

Next, in step S6070, the information gathering program 4120 executes an information acquisition processing for collecting the information on the change of configuration that has occurred via a management task (management operation).

Next, in step S6080, the information gathering program 4120 stores the information on the change of configuration gathered in step S6070 in the group of configuration differential information tables 4140.

The above has illustrated a processing according to embodiment 1 when the administrator of the virtual storage array 6000 executes management operation accompanying change of configuration with respect to the virtual storage array 6000 while the configuration management program 4110 is updating the configuration information of the storage array 1000 and the virtual storage array 6000 included in the storage array group 7000.

Other variations of the processes of steps S6060, S6070 and S6080 are possible. For example, the process of step S6080 does not necessarily have to be performed. In that case, regarding the result of the configuration management program 4110 updating the configuration information of the storage array 1000 and the virtual storage array 6000 included in the storage array group 7000, the result of the change of configuration executed for the virtual storage array 6000 will not be reflected by the administrator of the virtual storage array 6000. Therefore, in this case, the update result of the configuration information shows the configuration information of the time when information update was started.

Further, the processes of steps S6060, S6070 and S6080 can be changed so that, for example, the management task executed by the virtual storage administrator is stored in a queue, and the task is executed after completing update of the configuration information of the storage array 1000 and the virtual storage array 6000 included in the storage array group 7000.

The above has illustrated the data processing sequence according to embodiment 1. According to these processes, when the management software performs information update, the information update of the physical storage array and the virtual storage array can be performed without having to prohibit management operations from the virtual storage administrator. Since the manipulation operation of the virtual storage administrator is not prohibited, any arbitrary virtual storage administrator can change the configuration of the virtual storage array during update of information.

Further, in order to reduce the occurrence of change of configuration during information update, the order for updating information is changed dynamically based on the relationship between the physical storage array and the virtual storage array or between the virtual storage arrays, so that the update of information can be performed efficiently. Thereby, it becomes possible to avoid a situation where the virtual storage administrator cannot perform management operation to the virtual storage array for a long period of time, and the efficiency of operation management can be improved.

### Embodiment 2

### B1. System Configuration

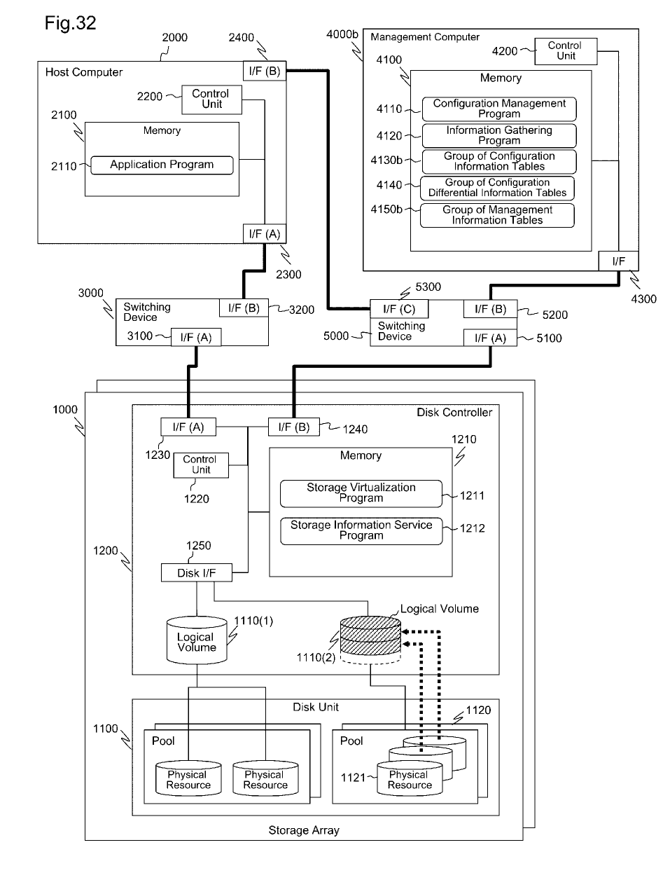

FIG. 32 is an explanatory view showing the configuration of a computer system according to one preferred embodiment of the present invention. The present computer system includes a storage array 1000, a host computer 2000, a switching device 3000, a management computer 4000b and a switching device 5000. In the drawings, the configuration includes two storage arrays 1000, one host computer 2000, one switching device 3000, one management computer 4000b and one switching device 5000, but the number of each component is not restricted thereto, and any number of one or more can be selected. The major portion of the present configuration is equivalent to the configuration of embodiment 1, so only the differences from embodiment 1 will be described hereafter.

The differences between the present computer system and the computer system illustrated in FIG. 1 are that the configuration of the group of configuration information tables 4130b included in the management computer 4000b differs from the group of configuration information tables 4130 included in the management computer 4000, and that the configuration of the group of management information tables 4150b differs from the configuration of the group of management information tables 4150.

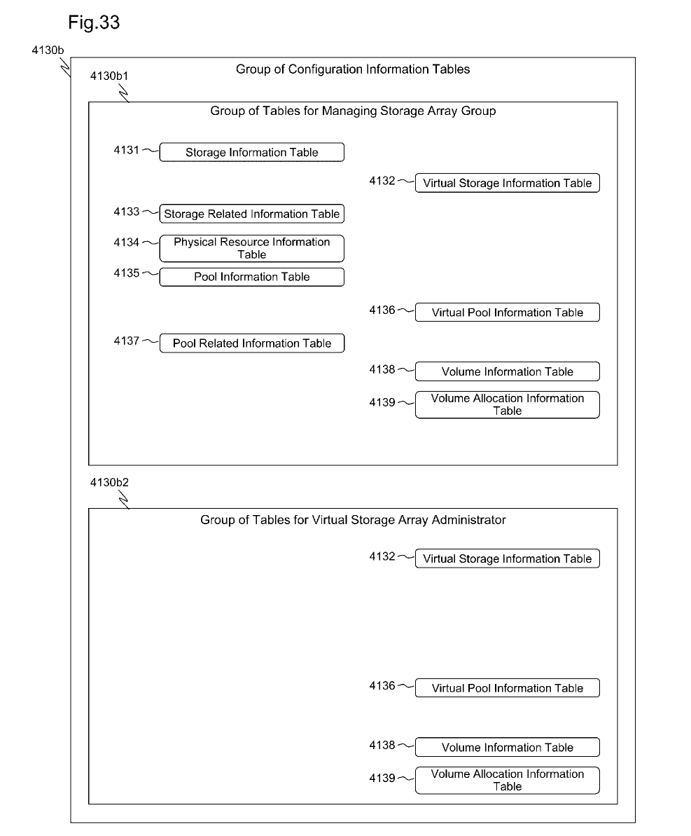

The actual example of the group of configuration information tables 4130b is shown in FIG. 33. The group of configuration information tables 4130b includes a group of tables 4130b1 for the storage array group administrator and a group of tables 4130b2 for the virtual storage array administrator. The group of tables 4130b1 for the storage array group administrator is a group of tables storing the configuration information referred to by the administrator of the storage array group 7000. The tables constituting the group of tables 4130b1 for the storage array group administrator are equivalent to the tables constituting the group of configuration information tables 4130 shown in FIG. 4. The group of tables 4130b2 for the virtual storage array administrator is the group of tables storing the configuration information referred to by the administrator of the virtual storage array 6000. The tables constituting the group of tables 4130b2 for the virtual storage array administrator are the virtual storage information table 4132, the virtual pool information table 4136, the volume information table 4138 and the volume allocation information table 4139 included in the group of configuration information tables 4130 shown in FIG. 4.

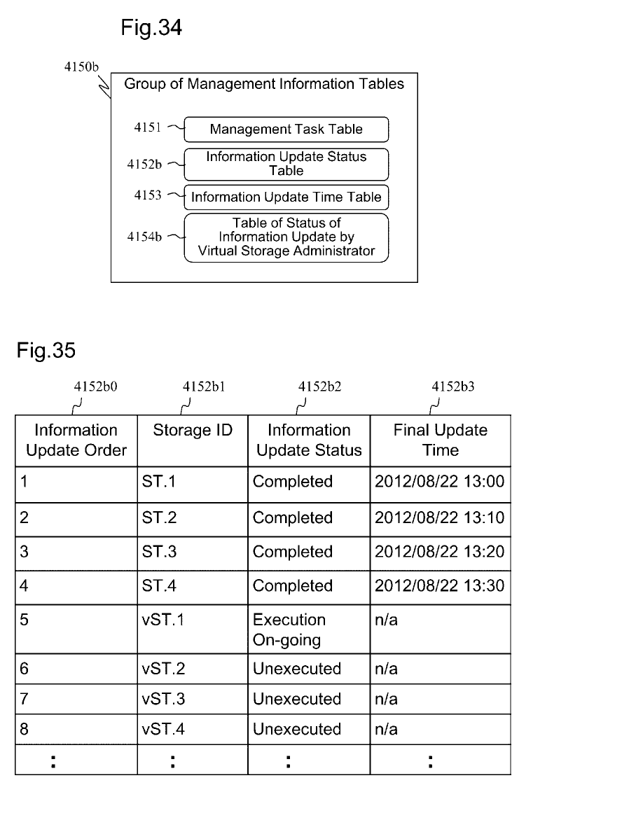

The actual examples of the group of management information tables 4150b are illustrated in FIG. 34. The differences between the group of management information tables 4150b and the group of management information tables 4150 illustrated in FIG. 21 are that the configuration of the information update status table 4152b differs from the configuration of the information update status table 4152, and that the group of management information tables 4150b includes an information update status table 4154b via the virtual storage administrator.

The actual example of the information update status table 4152b is shown in FIG. 35. The difference between the information update status table 4152b and the information update status table 4152 shown in FIG. 23 is that the information update status table 4152b includes a final update time 4152b3. The final update time 4152b3 refers to the information showing the date and time when the information update of the storage array 1000 and the virtual storage array 6000 has last been performed by the administrator of the storage array group 7000. If the information update status 4152b is “execution on-going” or “unexecuted”, the final update time 4152b3 stores “n/a” indicating a null value.

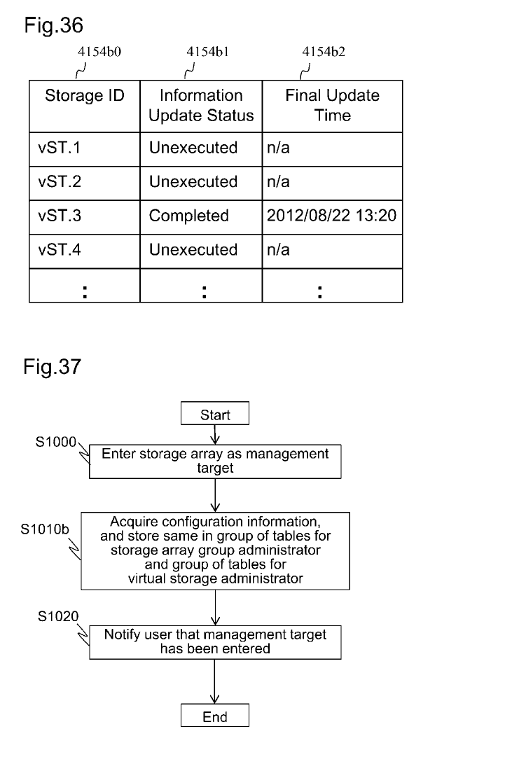

An actual example of the information update status table 4154b by the virtual storage administrator is shown in FIG. 36. The configuration of the information update status table 4154b by the virtual storage administrator is similar to the configuration of the information update status table 4152b, except that the present table does not include an information update order. As mentioned earlier, the information update status table 4152b stores records indicating the status of information update when the administrator of the storage array group 7000 performs information update of the storage array 1000 and the virtual storage array 6000 included in the group. In contrast, the information update status table 4154b by the virtual storage administrator stores records indicating the status of information update when the administrator of the virtual storage array 6000 performs information update of the virtual storage array 6000 that he/she manages.

### B2. Description of Data Processing Sequence

Major portions of the operation of the present embodiment 2 are the same as the operation of embodiment 1, so only the differences therefrom are described hereafter. The differences of the sequence of the processing of the present embodiment 2 from the sequence of the processing of embodiment 1 are that the process performed when the configuration management program 4110 records the storage array 1000 and the virtual storage array 6000 as management targets differs, that the process performed when the configuration management program 4110 updates the configuration information of the storage array 1000 and the virtual storage array 6000 included in storage array group 7000 differs, and that there exists a process where the configuration management program 4110 updates only the information related to the virtual storage array 6000.

FIG. 37 illustrates a sequence according to the present embodiment 2 where the configuration management program 4110 registers the storage array 1000 and the virtual storage array 6000 as management targets. The steps illustrated in FIG. 37 are the same as the steps illustrated in FIG. 25, except for the process of step S1010b.

In step S1010b, the configuration management program 4110 demands the information gathering program 4120 to collect configuration information from the storage array 1000 designated by the user in step S1000. The information gathering program 4120 collects configuration information by communicating with the storage information service program 1212 stored in the storage array 1000, and stores the collected configuration information in the group of configuration information tables 4130b. At this time, the configuration information of the storage array 1000 is stored only in the group of tables 4130b1 for the storage array group administrator. If a virtual storage array 6000 is formed within the storage array 1000, the configuration information of the virtual storage array 6000 is stored both in the group of tables 4130b1 for the storage array group administrator and the group of tables 4130b2 for the virtual storage array administrator.

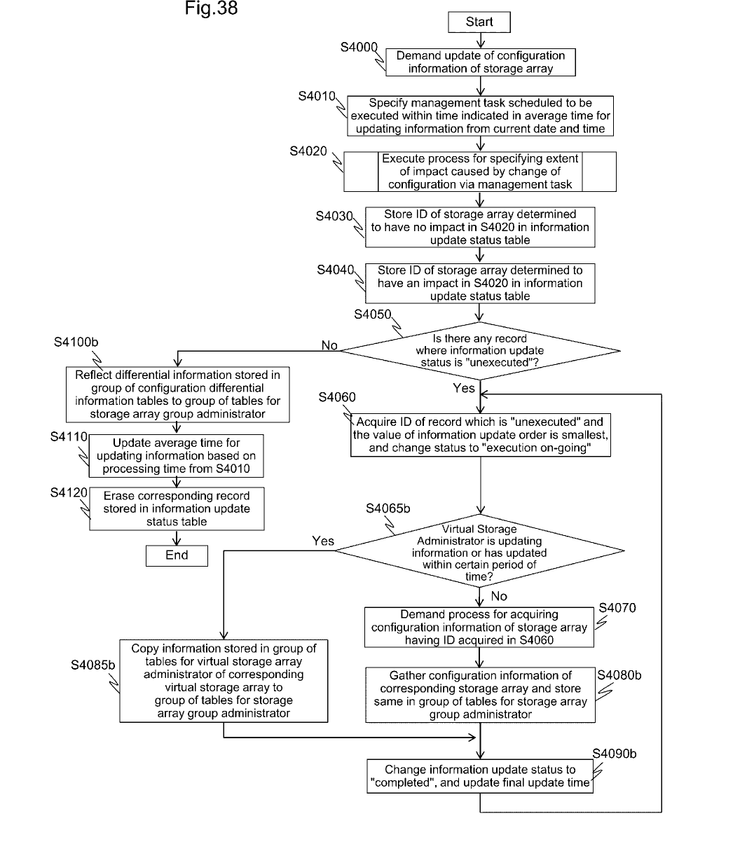

FIG. 38 shows a sequence of processing when the configuration management program 4110 updates the configuration information of the storage array 1000 and the virtual storage array 6000 included in the storage array group 7000 according to embodiment 2. The steps shown in FIG. 38 are the same as the steps of FIG. 28, except for the processes of steps S4065b, S4080b, S4085b, S4090b and S4100b.

In step S4065b, the configuration management program 4110 refers to the information update status table 4154b by the virtual storage administrator, and determines whether or not the virtual storage array 6000 shown by the storage ID (identifier) acquired in step S4060 is subjected to information update by the virtual storage administrator or has completed information update within a certain period of time from the current time. If information update is being performed or if the information update has been completed within a certain period of time from the current time, the procedure advances to step S4185b. If information update is not being performed and the information update has not been completed within a certain period of time from the current time, the procedure advances to step S4070.

In step S4080b, the information gathering program 4120 collects the configuration information of the storage array 1000 or the virtual storage array 6000, and stores the same in the group of tables 4130b1 for the storage array group administrator of the group of configuration information tables 4130b.

In step S4085b, regarding the virtual storage array 6000 shown by the storage ID (identifier) acquired in step S4060, the configuration management program 4110 copies the information stored in the group of tables 4130b2 for the virtual storage array administrator to a corresponding table in the group of tables 4130b1 for the storage array group administrator.

In step S4090b, the configuration management program 4110 changes the information update status 4152b2 of the information update status table 4152b to “completed”, and stores the current date and time at that point of time to the final update time 4152b3.

In step S4100b, if differential information is stored in the group of configuration differential information tables 4140, the configuration management program 4110 reflects the information in the group of tables 4130b1 for the storage array group administrator of the group of configuration information tables 4130b. The differential information in which reflection of information is completed is deleted from the group of configuration differential information tables 4140.

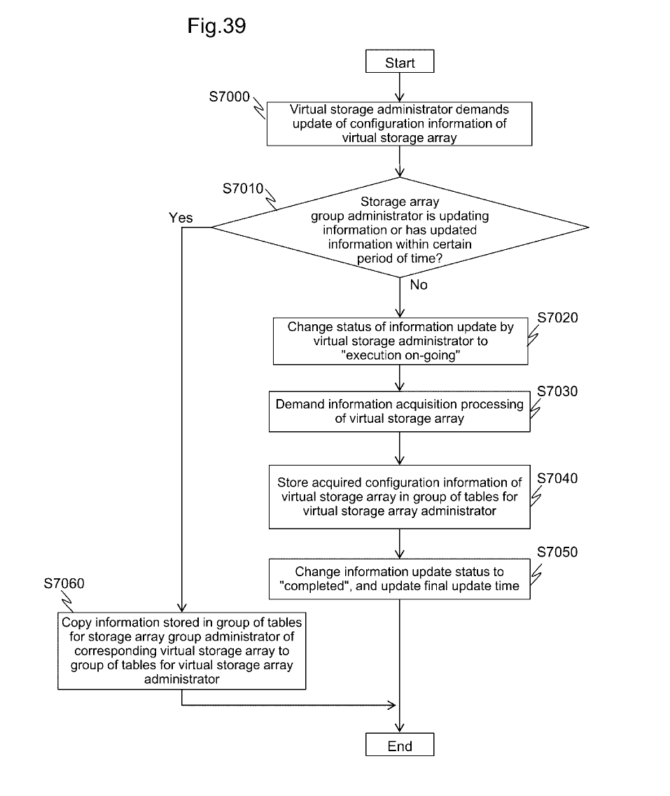

FIG. 39 shows a sequence of processing performed according to embodiment 2 where the administrator of the virtual storage array 6000 updates the configuration information of the virtual storage array 6000 that he/she manages.

In the present processing, at first in step S7000, the administrator of the virtual storage array 6000 demands to update the configuration information of the virtual storage array 6000 via the user interface of the configuration management program 4110.

Thereafter, in step S7010, the configuration management program 4110 refers to the information update status table 4152b, and determines whether or not the virtual storage array 6000 designated by the virtual storage administrator is subjected to information update by the storage array group administrator or has completed information update within a certain period of time from the current time. If information update is being performed or if the information update has been completed within a certain period of time from the current time, the procedure advances to step S7060. If information update is not being performed and the information update has not been completed within a certain period of time from the current time, the procedure advances to step S7020.

In step S7020, regarding the virtual storage array 6000 designated by the virtual storage administrator, the configuration management program 4110 changes the information update status of the information update status table 4154b by the virtual storage administrator to “execution on-going”.

Thereafter, in step S7030, the configuration management program 4110 demands the information gathering program 4120 to perform information acquisition processing of the virtual storage array 6000.

Next, in step S7040, the information gathering program 4120 collects the configuration information of the virtual storage array 6000, and stores the acquired configuration information in the group of tables 4130b2 for the virtual storage array administrator within the group of configuration information tables 4130b.

Thereafter, in step S7050, the configuration management program 4110 changes the information update status 4154b1 of the information update status table 4154b by the virtual storage administrator to “completed”, and stores the current date and time at that point of time to the final update time 4154b2.

On the other hand, in step S7060, regarding the virtual storage array 6000 designated by the virtual storage administrator, the configuration management program 4110 copies the information stored in the group of tables 4130b1 for the storage array group administrator to the corresponding table of the group of tables 4130b2 for the virtual storage array administrator.

The sequence of data processing according to embodiment 2 has been described above. According to these processes, even if the storage array group administrator or the virtual storage administrator updates information at independent timings, the present invention enables to prevent only a portion of the information from being updated to the latest state when seen from the storage array group administrator, and thus, the consistency of configuration information can be maintained as a whole.

Furthermore, if the update of information by the storage array group administrator and the update of information by the virtual storage administrator are executed at close timings, the present invention enables to prevent having to gather the same configuration information of the virtual storage array 6000 for multiple times, thereby shortening the information update time and reducing the load applied on the storage array.

### REFERENCE SIGNS LIST

1000 Storage Array
1100 Disk Unit
1110 Logical Volume
1120 Pool
1121 Physical Resource
1200 Disk Controller
1210 Memory
1211 Storage Virtualization Program
1212 Storage Information Service Program
1220 Control Unit
1230 I/F (A)
1240 I/F (B)
1250 Disk I/F
2000 Host Computer
2100 Memory
2110 Application Program
2200 Control Unit
2300 I/F (A)
2400 I/F (B)
3000 Switching Device
3100 I/F (A)
3200 I/F (B)
4000, 4000b Management Computer
4100 Memory
4110 Configuration Management Program
4120 Information Gathering Program
4130, 4130b Group of Configuration Information Tables
4130b1 Group of Tables for Storage Array Group Administrator
4130b2 Group of Tables for Virtual Storage Array Administrator
4131 Storage Information Table
4132 Virtual Storage Information Table
4133 Storage Related Information Table
4134 Physical Resource Information Table
4135 Pool Information Table
4136 Virtual Pool Information Table
4137 Pool Related Information Table
4138 Volume Information Table
4139 Volume Allocation Information Table
4140 Group of Configuration Differential Information Tables
4141 Storage Differential Information Table
4142 Virtual Storage Differential Information Table
4145 Pool Differential Information Table
4146 Virtual Pool Differential Information Table
4148 Volume Differential Information Table
4149 Volume Allocation Differential Information Table
4150 Group of Management Information Tables
4151 Management Task Table
4152, 4152b Information Update Status Table
4153 Information Update Time Table
4154b Information Update Status Table by Virtual Storage Administrator
4200 Control Unit
4300 I/F
5000 Switching Device
5100 I/F (A)
5200 I/F (B)
5300 I/F (C)
6000 Virtual Storage Array
6110 Logical Volume
6120 Virtual Pool
7000 Storage Array Group

1. A computer system comprising:
one or more storage arrays composed of one or more physical resources;
one or more virtual storage arrays composing one or more storage resources in the storage arrays as one or more virtualized storage resources; and
a management computer for managing the storage array and the virtual storage array;
wherein the management computer includes
a configuration information storage area for storing the configuration information of the storage array and the virtual storage array;
a configuration information gathering means for gathering the configuration information of the storage array and the virtual storage array; and
a configuration change storage area for storing the contents of change of configuration of the storage array and the virtual storage array;
wherein the configuration information is acquired via the configuration information gathering means without getting a lock for preventing the change of configuration of the storage array and the virtual storage array;
the contents of the change of configuration of the virtual storage array having occurred while acquiring the configuration information are stored in the configuration change storage area; and
the contents of the change of configuration stored in the configuration change storage area is reflected in the configuration information storage area when updating the configuration information by storing the acquired configuration information in the configuration information storage area.

2. The computer system according to claim 1, wherein
the management computer further
has a command storage area for storing a configuration change command with respect to the virtual storage array;
stores the configuration change command with respect to the virtual storage array having occurred while acquiring the configuration information to the command storage area; and
stores the contents of the change of configuration in the configuration change storage area and reflects the same in the configuration information storage area by executing the configuration change command stored in the command storage area after completing the process of updating the acquired configuration information.

3. The computer system according to claim 1, wherein
the management computer further
includes a command execution schedule table for performing change of configuration of the storage array and the virtual storage array;
refers to the execution schedule table and the configuration information storage area prior to acquiring the configuration information via the configuration information gathering means;
specifies the range of configuration change that occurs by executing the command based on the configuration information stored in the configuration information storage area and the configuration change command stored in the execution schedule table; and
determines an order of acquisition so that based on the specified range of change of configuration, an acquisition timing of the configuration information via the configuration information gathering means is set later than an execution timing of the configuration change command.

4. The computer system according to claim 3, wherein
the management computer
re-specifies a range of change of configuration that has occurred by the change of configuration of the virtual storage array executed while acquiring the configuration information; and
changes the order of acquisition so that based on the re-specified range of change of configuration, the timing for acquiring the configuration information via the configuration information gathering means is set later than the execution timing of the configuration change command.

5. The computer system according to claim 1, wherein
the management computer further
provides as the configuration information storage area a first configuration information storage area for storing each configuration information of the storage array and the virtual storage array, and a second configuration information storage area for storing the configuration information of only the virtual storage array;
divides the process for updating the configuration information into a first information update processing for updating the configuration information stored in the first configuration information storage area based on the configuration information of the storage array and the virtual storage array acquired by the configuration information gathering means and a second information update processing for updating the configuration information stored in the second configuration information storage area based on the configuration information of the virtual storage array acquired by the configuration information gathering means;
when executing the first information update processing and the second information update processing in parallel as the process for updating the configuration information stored in the configuration information storage area,
if a process for acquiring the configuration information of the virtual storage array has been executed in advance by the first information update processing, the process for acquiring the configuration information of the virtual storage array by the second information update processing will not be executed, whereas after updating the configuration information of the virtual storage array stored in the first configuration information storage area via the first information update processing, the configuration information of the virtual storage array stored in the second configuration information storage area is updated using the configuration information of the virtual storage array stored in the first configuration information storage area; and
if a process for acquiring the configuration information of the virtual storage array has been executed in advance by the second information update processing, the process for acquiring the configuration information of the virtual storage array by the first information update processing will not be executed, whereas after updating the configuration information of the virtual storage array stored in the second configuration information storage area via the second information update processing, the configuration information of the virtual storage array stored in the first configuration information storage area is updated using the configuration information of the virtual storage array stored in the second configuration information storage area.

6. A method for updating configuration information comprising:
a step of acquiring a configuration information of a storage array and a virtual storage array without getting a lock for preventing the change of configuration of one or more storage arrays and one or more virtual storage arrays;
a step of storing a content of the change of configuration of the virtual storage array having occurred while acquiring the configuration information in a configuration change storage area of a management computer;
a step of updating the configuration information by storing the acquired configuration information in a configuration information storage area of the management computer; and
a step of reflecting in the configuration information storage area the content of the change of configuration stored in the configuration change storage area when the configuration information is updated.

7. The method for updating configuration information according to claim 6, further comprising
a step of specifying a range of change of configuration that occurs by executing a configuration change command based on the configuration change command of the storage array and the virtual storage array and a configuration information stored in the configuration information storage area; and
a step of determining an order of acquisition so that based on the range of change of configuration, a timing for acquiring the configuration information is set later than an execution timing of the configuration change command.

8. The method for updating configuration information according to claim 7, further comprising
a step of re-specifying a range of change of configuration that has occurred by the change of configuration of the virtual storage array executed while acquiring the configuration information; and
a step of changing the order of acquisition so that based on the re-specified range of change of configuration, the timing for acquiring the configuration information is set later than the execution timing of the configuration change command.
